(19) United States
(12) Patent Application Publication
(10) Pub. No.: US 2024/0205668 A1
(43) Pub. Date: Jun. 20, 2024

(54) CAPABILITY INDICATION FOR A MULTI-BLOCK MACHINE LEARNING MODEL

(71) Applicant: QUALCOMM INCORPORATED, San Diego, CA (US)

(72) Inventors: Yuwei Ren, Beijing (CN); Huilin Xu, Temecula, CA (US)

(21) Appl. No.: 18/555,501

(22) PCT Filed: Jul. 2, 2021
(86) PCT No.: PCT/CN2021/104251

§ 371 Date: Oct. 13, 2023

(51) Int. Cl. H04W 8/24; H04W 72/21

(52) U.S. Cl. CPC H04W 8/24; H04W 72/21

(57) ABSTRACT

Methods, systems, and devices for wireless communications are described. A user equipment (UE) may indicate a support for an end-to-end multi-block machine learning application, a first UE capability for a backbone block of the multi-block machine learning application that makes up one or more front-end layers (e.g., one or more backbone layers), a second UE capability for a task-specific block of the multi-block machine learning application that makes up the end layer (s) of the end-to-end model (e.g., one or more task-specific layers), or a combination thereof. In some examples, the UE may transmit separate indications for the first UE capability and for the second UE capability. Additionally or alternatively, the UE may transmit a general machine learning capability indication, where a base station then determines the first UE capability for the base stage and the second UE capability for the task-specific stage from the general machine learning capability.

### CROSS REFERENCE

The present Application is a 371 national stage filing of International PCT Application No. PCT/CN2021/104251 by Ren et al. entitled “CAPABILITY INDICATION FOR A MULTI-BLOCK MACHINE LEARNING MODEL,” filed Jul. 2, 2021, which is assigned to the assignee hereof, and which is expressly incorporated by reference in its entirety herein.

### FIELD OF TECHNOLOGY

The following relates to wireless communications, including capability indication for a multi-block machine learning model.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some examples, a UE may use machine learning for enhancing different operations. Improved techniques for enabling machine learning may be desired.

### SUMMARY

The described techniques relate to improved methods, systems, devices, and apparatuses that support capability indication for a multi-block machine learning model. Generally, the described techniques provide for a user equipment (UE) to use a multi-block machine learning application for enhancing communications. In some examples, the multi-block machine learning application may include a backbone block (e.g., one or more backbone layers, a backbone model, etc.) and a task-specific block (e.g., one or more task-specific layers, a task-specific model, etc.), and the UE may be configured with the backbone block and the task-specific block via one or more control messages from a base station. As described herein, to support the base station determining the configuration of the backbone block and the task-specific block for the multi-block machine learning application, the UE may transmit capability information indicating a capability of the UE to support the multi-block machine learning application (e.g., an end-to-end multi-block machine learning application), including a first UE capability for the backbone block and a second UE capability for the task-specific block (e.g., at least one task-specific stage). In some examples, the UE may transmit separate indications for the first UE capability and for the second UE capability. Additionally or alternatively, the UE may transmit a general machine learning capability indication, where the base station then determines the first UE capability for the backbone block and the second UE capability for the task-specific block from the general machine learning capability.

A method for wireless communications at a UE is described. The method may include transmitting, to a base station, an indication identifying a first UE capability for a backbone block of a multi-block machine learning application and a second UE capability for a task-specific block of the multi-block machine learning application, receiving, from the base station, control signaling identifying a configuration for the multi-block machine learning application of the UE at least in part in response to the indication identifying the first UE capability and the second UE capability, and communicating with the base station or a wireless device using the multi-block machine learning application configured in accordance with the control signaling.

An apparatus for wireless communications at a UE is described. The apparatus may include a processor, memory coupled with the processor, and instructions stored in the memory. The instructions may be executable by the processor to cause the apparatus to transmit, to a base station, an indication identifying a first UE capability for a backbone block of a multi-block machine learning application and a second UE capability for a task-specific block of the multi-block machine learning application, receive, from the base station, control signaling identifying a configuration for the multi-block machine learning application of the UE at least in part in response to the indication identifying the first UE capability and the second UE capability, and communicate with the base station or a wireless device using the multi-block machine learning application configured in accordance with the control signaling.

Another apparatus for wireless communications at a UE is described. The apparatus may include means for transmitting, to a base station, an indication identifying a first UE capability for a backbone block of a multi-block machine learning application and a second UE capability for a task-specific block of the multi-block machine learning application, means for receiving, from the base station, control signaling identifying a configuration for the multi-block machine learning application of the UE at least in part in response to the indication identifying the first UE capability and the second UE capability, and means for communicating with the base station or a wireless device using the multi-block machine learning application configured in accordance with the control signaling.

A non-transitory computer-readable medium storing code for wireless communications at a UE is described. The code may include instructions executable by a processor to transmit, to a base station, an indication identifying a first UE capability for a backbone block of a multi-block machine learning application and a second UE capability for a task-specific block of the multi-block machine learning application, receive, from the base station, control signaling identifying a configuration for the multi-block machine learning application of the UE at least in part in response to the indication identifying the first UE capability and the second UE capability, and communicate with the base station or a wireless device using the multi-block machine learning application configured in accordance with the control signaling.

Some examples of the method, apparatuses, and non-transitory computer-readable medium described herein may further include operations, features, means, or instructions for transmitting, to the base station, an indication that the UE supports the multi-block machine learning application, where the control signaling configuring the multi-block machine learning application of the UE may be received in response to the indication that the UE supports the multi-block machine learning application.

In some examples of the method, apparatuses, and non-transitory computer-readable medium described herein, transmitting the indication identifying the first UE capability and the second UE capability may include operations, features, means, or instructions for transmitting a first indicator identifying, for the UE, one capability level of a set of capability levels associated with the backbone block, the one capability level identifying the first UE capability for the backbone block.

In some examples of the method, apparatuses, and non-transitory computer-readable medium described herein, transmitting the indication identifying the first UE capability and the second UE capability may include operations, features, means, or instructions for transmitting a set of multiple indicators that identify a set of multiple capability parameters, the set of multiple capability parameters collectively identifying the first UE capability for the backbone block, and each indicator of the set of multiple indicators corresponding to a respective capability parameter of the set of multiple capability parameters.

In some examples of the method, apparatuses, and non-transitory computer-readable medium described herein, transmitting the indication identifying the first UE capability and the second UE capability may include operations, features, means, or instructions for transmitting a second indicator identifying a set of tasks that the UE supports for the task-specific block of the multi-block machine learning application, scenarios the UE supports for the task-specific block of the multi-block machine learning application, or a combination thereof.

In some examples of the method, apparatuses, and non-transitory computer-readable medium described herein, transmitting the indication identifying the first UE capability and the second UE capability may include operations, features, means, or instructions for transmitting an indicator of a machine learning capability of the UE, where the machine learning capability may be associated with a combination of the backbone block and the task-specific block.

In some examples of the method, apparatuses, and non-transitory computer-readable medium described herein, the machine learning capability of the UE includes an indicator that the UE supports the multi-block machine learning application and a set of indicators identifying the machine learning capability associated with the combination of the backbone block and the task-specific block.

In some examples of the method, apparatuses, and non-transitory computer-readable medium described herein, the machine learning capability of the UE includes, for the combination of the backbone block and the task-specific block, a supported size, a supported operation, a machine learning structure type, a supported condition, a supported task, a supported scenario, or a combination thereof.

In some examples of the method, apparatuses, and non-transitory computer-readable medium described herein, the indication identifying the first UE capability and the second UE capability may include operations, features, means, or instructions for an indication of neural network types for the backbone block supported by the UE, machine learning model size levels for the backbone block supported by the UE, operation levels for the backbone block supported by the UE, or a combination thereof and an indication of tasks, scenarios, or a combination thereof, that the UE supports for the task-specific block.

A method for wireless communications at a network entity is described. The method may include receiving, from a UE, an indication identifying a first UE capability for a backbone block of a multi-block machine learning application and a second UE capability for a task-specific block of the multi-block machine learning application, transmitting, to the UE in response to the first UE capability and the second UE capability, control signaling to configure the multi-block machine learning application of the UE, and communicating with the UE based on the control signaling.

An apparatus for wireless communications at a network entity is described. The apparatus may include a processor, memory coupled with the processor, and instructions stored in the memory. The instructions may be executable by the processor to cause the apparatus to receive, from a UE, an indication identifying a first UE capability for a backbone block of a multi-block machine learning application and a second UE capability for a task-specific block of the multi-block machine learning application, transmit, to the UE in response to the first UE capability and the second UE capability, control signaling to configure the multi-block machine learning application of the UE, and communicate with the UE based on the control signaling.

Another apparatus for wireless communications at a network entity is described. The apparatus may include means for receiving, from a UE, an indication identifying a first UE capability for a backbone block of a multi-block machine learning application and a second UE capability for a task-specific block of the multi-block machine learning application, means for transmitting, to the UE in response to the first UE capability and the second UE capability, control signaling to configure the multi-block machine learning application of the UE, and means for communicating with the UE based on the control signaling.

A non-transitory computer-readable medium storing code for wireless communications at a network entity is described. The code may include instructions executable by a processor to receive, from a UE, an indication identifying a first UE capability for a backbone block of a multi-block machine learning application and a second UE capability for a task-specific block of the multi-block machine learning application, transmit, to the UE in response to the first UE capability and the second UE capability, control signaling to configure the multi-block machine learning application of the UE, and communicate with the UE based on the control signaling.

Some examples of the method, apparatuses, and non-transitory computer-readable medium described herein may further include operations, features, means, or instructions for receiving, from the UE, an indication that the UE supports the multi-block machine learning application, where the control signaling configuring the multi-block machine learning application of the UE may be transmitted based on the UE supporting the multi-block machine learning application.

In some examples of the method, apparatuses, and non-transitory computer-readable medium described herein, receiving the indication identifying the first UE capability and the second UE capability may include operations, features, means, or instructions for receiving a first indicator identifying, for the UE, one capability level of a set of capability levels associated with the backbone block, the one capability level identifying the first UE capability for the backbone block.

In some examples of the method, apparatuses, and non-transitory computer-readable medium described herein, receiving the indication identifying the first UE capability and the second UE capability may include operations, features, means, or instructions for receiving a set of multiple indicators that identify a set of multiple capability parameters, the set of multiple capability parameters collectively identifying the first UE capability for the backbone block, and each indicator of the set of multiple indicators corresponding to a respective capability parameter of the set of multiple capability parameters.

In some examples of the method, apparatuses, and non-transitory computer-readable medium described herein, receiving the indication identifying the first UE capability and the second UE capability may include operations, features, means, or instructions for receiving a second indicator identifying a set of tasks that the UE supports for the task-specific block of the multi-block machine learning application, scenarios the UE supports for the task-specific block of the multi-block machine learning application, or a combination thereof.

In some examples of the method, apparatuses, and non-transitory computer-readable medium described herein, receiving the indication identifying the first UE capability and the second UE capability may include operations, features, means, or instructions for receiving an indicator of a machine learning capability of the UE, where the machine learning capability may be associated with a combination of the backbone block and the task-specific block and determining the first UE capability for the backbone block and the second UE capability for the task-specific block based on the machine learning capability that may be associated with the combination of the backbone block and the task-specific block.

In some examples of the method, apparatuses, and non-transitory computer-readable medium described herein, the machine learning capability of the UE includes an indicator that the UE supports the multi-block machine learning application and a set of indicators identifying the machine learning capability associated with the combination of the backbone block and the task-specific block.

In some examples of the method, apparatuses, and non-transitory computer-readable medium described herein, the machine learning capability of the UE includes, for the combination of the backbone block and the task-specific block, a supported size, a supported operation, a machine learning structure type, a supported condition, a supported task, a supported scenario, or a combination thereof.

In some examples of the method, apparatuses, and non-transitory computer-readable medium described herein, the indication identifying the first UE capability and the second UE capability may include operations, features, means, or instructions for an indication of neural network types for the backbone block supported by the UE, machine learning model size levels for the backbone block supported by the UE, operation levels for the backbone block supported by the UE, or a combination thereof and an indication of tasks, scenarios, or a combination thereof, that the UE supports for the task-specific block.

### BRIEF DESCRIPTION OF THE DRAWINGS

FIG. 1 illustrates an example of a wireless communications system that supports a capability indication for a multi-block machine learning model in accordance with aspects of the present disclosure.

FIG. 2 illustrates an example of a wireless communications system that supports a capability indication for a multi-block machine learning model in accordance with aspects of the present disclosure.

FIGS. 3 and 4 illustrate examples of process flows that support a capability indication for a multi-block machine learning model in accordance with aspects of the present disclosure.

FIG. 5 illustrates an example of a wireless communications system that supports a capability indication for a multi-block machine learning model in accordance with aspects of the present disclosure.

FIGS. 6 and 7 show block diagrams of devices that support a capability indication for a multi-block machine learning model in accordance with aspects of the present disclosure.

FIG. 8 shows a block diagram of a communications manager that supports a capability indication for a multi-block machine learning model in accordance with aspects of the present disclosure.

FIG. 9 shows a diagram of a system including a device that supports a capability indication for a multi-block machine learning model in accordance with aspects of the present disclosure.

FIGS. 10 and 11 show block diagrams of devices that support a capability indication for a multi-block machine learning model in accordance with aspects of the present disclosure.

FIG. 12 shows a block diagram of a communications manager that supports a capability indication for a multi-block machine learning model in accordance with aspects of the present disclosure.

FIG. 13 shows a diagram of a system including a device that supports a capability indication for a multi-block machine learning model in accordance with aspects of the present disclosure.

FIGS. 14 through 20 show flowcharts illustrating methods that support a capability indication for a multi-block machine learning model in accordance with aspects of the present disclosure.

### DETAILED DESCRIPTION

In some wireless communications systems, a user equipment (UE) may use machine learning to improve communications and performance. For example, a UE may use an end-to-end machine learning application that includes multiple layers to perform various tasks. To update the machine learning application (e.g., when conditions change), the UE may download (e.g., receive) another end-to-end machine learning application from a base station. But downloading another end-to-end machine learning application may be inefficient (e.g., due to the size of the application). For example, downloading another end-to-end machine learning application take a lot of time and consume many resources, among other disadvantages, which may negatively impact UE performance. Additionally, the end-to-end machine learning model may not take into account capabilities of the UE, which may result in a conservative machine learning model for the UE (e.g., the UE is capable of using a more complex machine learning model) or an incautious machine learning model (e.g., an overly complex machine learning model that the UE is incapable of using).

According to the techniques described herein, a UE may use a multi-block machine learning application that includes at least a backbone block and a task-specific block based on the UE transmitting capability information indicating a capability of the UE to support an end-to-end multi-block machine learning application, including a first UE capability corresponding to a supported backbone block of the multi-block machine learning application that makes up one or more front-end layers (e.g., one or more backbone layers) and a second UE capability corresponding to a supported task-specific block of the multi-block machine learning application that makes up the end layer(s) of the end-to-end model (e.g., one or more task-specific layers). For the reported backbone block UE capability, the UE may indicate machine learning model types of a backbone block that are supported (e.g., convolutional neural network (CNN), fully connected (FC) network, long short-term memory (LSTM) network, transformer network, etc.), a level of the model size that is supported (e.g., kilobyte (KB) level, megabyte (MB) level, 10 MB level, etc.), a level of the operations that is supported (e.g., 1 k flops, 10 k flops, 100 k flops, etc.). For the reported task-specific block UE capability, the UE may indicate what tasks the UE supports, what scenarios the UE supports, etc.

In some examples, the UE may transmit separate indications for the first UE capability and for the second UE capability. Additionally or alternatively, the UE may transmit a general machine learning capability indication, where a base station then determines the first UE capability for the backbone block and the second UE capability for the task-specific block from the general machine learning capability. A backbone block of a multi-block machine learning application may also be referred to as a base model, a backbone model, a backbone stage, or a base stage, and a task-specific block of a multi-block machine learning application may also be referred to as a task-specific stage, a task-specific model, a specific stage, or a specific model.

Aspects of the disclosure are initially described in the context of wireless communications systems. Additionally, aspects of the disclosure are illustrated through additional wireless communications systems and process flows. Aspects of the disclosure are further illustrated by and described with reference to apparatus diagrams, system diagrams, and flowcharts that relate to capability indication for a multi-block machine learning model.

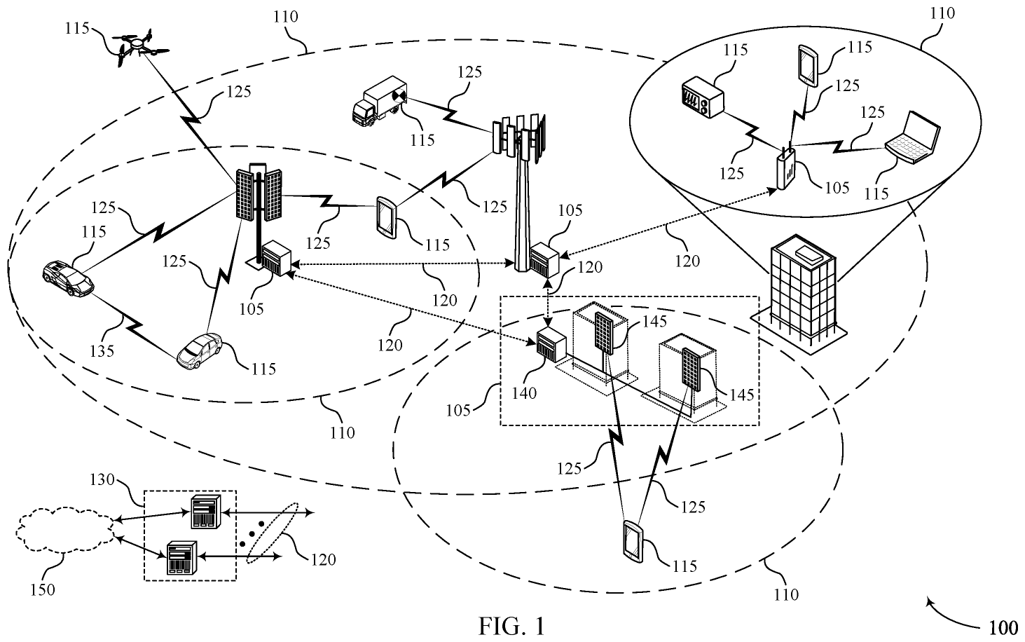

FIG. 1 illustrates an example of a wireless communications system 100 that supports capability indication for a multi-block machine learning model in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, the wireless communications system 100 may be an example of a network, for example a wireless backhaul communications network, such as an IAB network, among other various examples. An IAB network may include an IAB donor (or “anchor”) node and one or more relay (or “intermediate”) nodes downstream from the donor node. An IAB network may share resources between access and backhaul links such that access traffic may be relayed on a wireless backhaul link. In some cases, the same technology and techniques may be used for access links and backhaul links. IAB donor nodes may provide access to child UEs and the wireless backhaul functionality to IAB nodes. An IAB donor may include a CU for control of the IAB-network and one or more DUs for scheduling IAB nodes. An IAB donor may have a wireline connection to the core network 130. Downstream from the IAB donor node the network may include one or more IAB nodes (also referred to as one or more of parent nodes, relay nodes, intermediate nodes, or child nodes, depending upon where the node is within the IAB network) within the IAB network, with each wirelessly relaying traffic of one or more other nodes, such as its child nodes (e.g., UEs, or other IAB nodes), to one or more other nodes, such as the parent node (e.g., IAB donor, or IAB node). A UE 115 may connect wirelessly to an IAB donor node that is within range of the UE 115. In some cases, a base station 105 may be an example of a donor IAB node.

An IAB donor node may be functionally split into associated base station central unit (CU) and distributed unit (DU) entities (or “functions”), where one or more DUs associated with an IAB donor node may be partially controlled by an associated CU. CUs of IAB donor nodes may host layer 3 (L3) (e.g., RRC, service data adaption protocol (SDAP), PDCP) functionality and signaling. Further, CUs of IAB donor nodes may communicate with the core network over a wireline backhaul link (e.g., which may be referred to as an NG interface). DUs may host lower layer operations, such as layer 1 (L1) or layer 2 (L2) (e.g., RLC, MAC, physical layer) functionality and signaling. A DU entity of an IAB donor node may support a serving cell within the network coverage area according to connections associated with wireless backhaul links and access links of the IAB network. DUs of the IAB donor nodes may control both access and backhaul links within the corresponding network coverage and may provide controlling and scheduling for descendant (i.e., child, relay) IAB nodes and or UEs 115. For example, a DU may support an RLC channel connection with a UE 115 (e.g., via an access link) or with an IAB node (e.g., via a backhaul link, such as a primary wireless backhaul link or a backup wireless backhaul link). A DU of a node may be responsible for relaying (e.g., transporting, forwarding) messages from another node (e.g., to a CU and/or the core network) so that the other node can register with the core network and establish a secure radio resource control (RRC) connection with the CU of a donor node.

In some examples, a UE 115 may implement machine learning techniques to improve performance. For example, a UE 115 may use an end-to-end machine learning application to perform mobility management, to perform beam management, or to report channel state information (CSI) feedback (CSF), among other operations. The machine learning application used by a UE 115 may be received from a base station 105. To update the machine learning application (e.g., to accommodate new conditions or perform new tasks), the UE 115 may receive another end-to-end machine learning application from the base station 105. However, signaling a new end-to-end machine learning application may take a lot of time and consume many resources (e.g., communication resources, processing resources). Additionally, the end-to-end machine learning application model may not take into account capabilities of the UE 115, which may result in a conservative machine learning model for the UE 115 (e.g., the UE 115 is capable of using a more complex machine learning model) or an incautious machine learning model (e.g., an overly complex machine learning model that the UE 115 is incapable of using).

According to the techniques described herein, a UE 115 may enable an enhanced machine learning application model determination by a base station 105 based on capability signaling sent from the UE 115 to the base station 105 that includes capability information supported by the UE 115 for the machine learning application model. For example, the UE 115 may indicate a support for an end-to-end multi-block machine learning application, a first UE capability for a backbone block of the multi-block machine learning application that makes up one or more front-end layers (e.g., one or more backbone layers), a second UE capability for a task-specific block of the multi-block machine learning application that makes up the end layer(s) of the end-to-end model (e.g., one or more task-specific layers), or a combination thereof. In some examples, the UE 115 may transmit separate indications for the first UE capability and for the second UE capability. Additionally or alternatively, the UE 115 may transmit a general machine learning capability indication, where a base station then determines the first UE capability for the backbone block and the second UE capability for the task-specific block from the general machine learning capability.

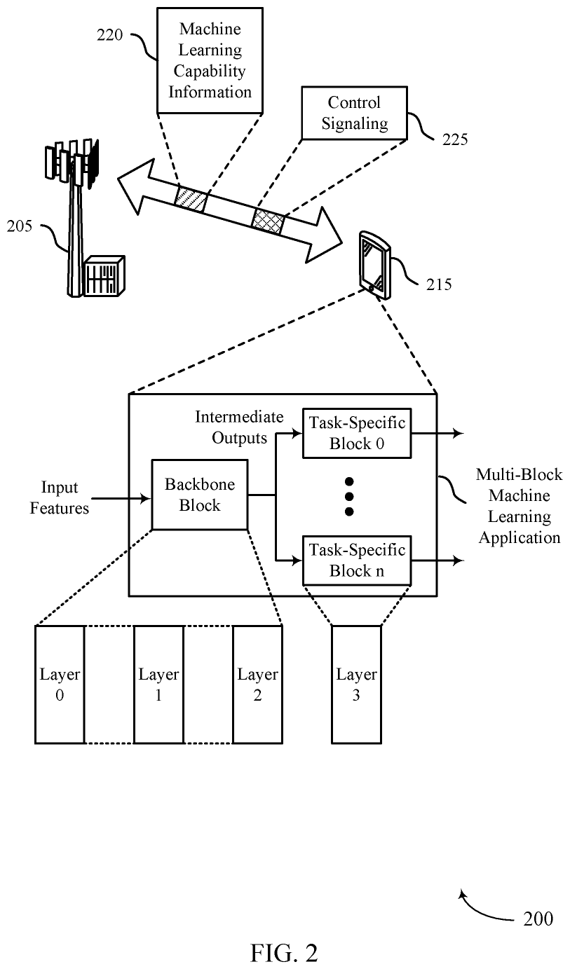

FIG. 2 illustrates an example of a wireless communications system 200 that supports a capability indication for a multi-block machine learning model in accordance with aspects of the present disclosure. The wireless communications system 200 may include a base station 205 and a UE 215, which may be examples of a base station 105 and a UE 115, respectively, as described with reference to FIG. 1. The base station 205 and the UE 215 may implement aspects of the techniques described herein so that the base station 205 can efficiently configure and signal configurations for multi-block machine learning applications.

The UE 215 may use one or more multi-block machine learning applications, each of which may include a backbone block and one or more task-specific block. For example, a backbone block and a task-specific block may be combined as a single multi-block machine learning application model or configuration. In some examples, a multi-block machine learning application may be built by the UE 215 and the base station 205 working together (e.g., as a neural network, such as a deep neural network). For example, to build a machine learning application for CSF reporting the UE 215 may serve as an encoder in the neural network and the base station 205 may serve as the decoder in the neural network. As the encoder, the UE 215 may use the characteristics of an estimated channel as input features for the machine learning and may communicate feedback generated by the machine learning to the base station 205, which, as the decoder, may output latent code based on the feedback. Different channel types may be associated with different task-specific blocks.

A backbone block may include one or more layers (e.g., algorithms), each of which may have a corresponding set of parameters (e.g., coefficients, ratios, weights, weight sets). For example, the backbone block shown in FIG. 2 may include three layers (front-end layers 0 through 2), each of which may have a corresponding set of parameters. A layer may also be referred to as a block or other suitable terminology, and the layers that make up a model may be referred to as the structure of the model. The backbone block may operate on various input features (e.g., data, information) associated with operations of the UE 215 and may generate various intermediate outputs based on the input features. In some examples, the wireless communications system 200 may pre-train the backbone block and fix the backbone block (e.g., maintain the backbone model as-is) for use with various task-specific blocks during an application update. Such a technique may be more efficient than re-training and downloading the backbone model each time an update is performed.

The task-specific blocks may also be made up of one or more layers (e.g., back-end layers), each of which may have a corresponding set of parameters. The task-specific blocks may operate on intermediate outputs from the backbone block and may generate one or more outputs that the UE 215 can use for various operations. As an example, the backbone block may operate on channel information (e.g., reference signal characteristics, estimated channel characteristics) and generate intermediate outputs that the task-specific blocks can use to perform angle estimation or precoder generation. The UE 215 may then use the estimated angle, generated precoder, or both for communication of a message with the base station 205. In some examples, the wireless communications system 200 may train, optimize, and download one or more task-specific blocks during an application update, which may be more efficient than training, optimizing, and downloading both blocks.

Thus, a backbone block and a task-specific block may collectively form an end-to-end machine learning application. The backbone block may support various operations (e.g., beam management, mobility management, CSF reporting), and a task-specific block may support a specific task for an operation. Further, each block may be associated with a corresponding set of conditions with which that block is compatible or capable of properly functioning. For example, the backbone block may be designed or used for an overarching operation or application (e.g., positioning), and the task-specific block may be mapped to different channel conditions for performing the overarching operation or application.

In some examples, the UE 215 may use a multi-block machine learning application that includes three or more block. For example, the UE 215 may use a three-block machine learning application that includes a backbone block, a task-specific block, and an intermediate block between the backbone block and the task-specific block. The intermediate block may also be referred to as a neck model or a neck block. Although described with reference to two-block applications, the techniques described herein may be applied to multi-block machine learning applications with different quantities of blocks or models.

As described herein, the UE 215 may transmit machine learning capability information 220 to the base station 205 that indicates machine learning capabilities of the UE 215. For example, the UE 215 may indicate UE capabilities for different machine learning model configurations, including UE capabilities for backbone blocks of a multi-block machine learning application configuration (e.g., backbone model, one or more backbone layers, etc.), for task-specific blocks of the multi-block machine learning application configuration (e.g., task-specific model, one or more task-specific layers, etc.), or both. In some examples, the UE capabilities for the backbone blocks may be related to a UE computation capability, and the UE capabilities for the task-specific blocks may be related to a UE function capability. Additionally, the machine learning capability information 220 may include an overall UE capability for machine learning capabilities supported by the UE 215, including a first UE capability for the backbone blocks supported by the UE 215 and a second UE capability for the task-specific blocks supported by the UE 215. In some examples, the UE 215 may also indicate that UE 215 supports using the multi-block machine learning application configuration in the machine learning capability information 220. For example, the UE 215 may transmit one (1) bit to indicate whether the UE 215 supports the multi-block machine learning application configuration, a backbone block configuration, task-specific blocks, or a combination thereof.

Accordingly, the base station 205 may then determine a machine learning model application configuration for the UE 215 to use, where the machine learning model application configuration includes a backbone block based on the first UE capability signaled from the UE 215 for the supported types of backbone blocks and one or more task-specific blocks based on the second UE capability signaled from the UE 215 for the supported types of task-specific blocks. Subsequently, the base station 205 may transmit control signaling 225 to the UE 215 that indicates the machine learning model application configuration for the UE 215 to use. As such, by having the base station 205 determine and signal the machine learning model application configuration via the control signaling 225 based on the machine learning capability information 220, the techniques described herein may support an efficient machine learning model application configuration that takes the machine learning capabilities of UE 215 into account, increasing the chances that the machine learning model application configuration is neither too conservative nor too incautious for the UE 215.

As described previously, the machine learning capability information 220 may include a first UE capability for backbone blocks, backbone configurations, backbone layer(s), or a backbone model supported by the UE 215 for the multi-block machine learning application. For example, before downloading the backbone block for the multi-block machine learning application, the UE 215 may transmit UE capability reporting (e.g., in the machine learning capability information 220) as part of establishing a connection with the base station 205. As the backbone block may involve most of the complexity of the overall machine learning model, different backbone blocks may require different UE capabilities. In the connection with the base station 205, in addition to indicating a support for the multi-block machine learning application configuration, a backbone block configuration, task-specific blocks, or a combination thereof, the UE 215 may transmit the machine learning capability information 220 as part of UE capability reporting to indicate the first UE capability for backbone blocks supported by the UE 215.

For example, the first UE capability for backbone blocks supported by the UE 215 in the machine learning capability information 220 may include an indication of what type of backbone blocks are supported by the UE 215, a level of a model size supported by the UE 215, a level of a number of operations supported by the UE 215, or a combination thereof. In some examples, the different types of machine learning models for the backbone blocks supported by the UE 215 may include different machine learning models supported by the UE 215 for one or more backbone layers of the multi-block machine learning application, such as a CNN, an FC network, an LSTM network, a transformer network, or a different type of machine learning model/network. For the different levels of model sizes supported by the UE 215, the UE 215 may indicate different threshold levels of model sizes that the UE 215 can support for the backbone block of the multi-block machine learning application, such as at a kilobyte (KB) level, a megabyte (MB) level, a 10 MB level, etc. Additionally, for indicating the different levels for the numbers of operations supported by the UE 215, the UE 215 may indicate different threshold levels of a number of operations that the UE 215 can support for the backbone model, such as 1,000 flops (e.g. 1K flops), 10,000 flops (e.g., 10K flops), 100,000 flops (e.g., 100K flops), etc.

To report the first UE capability for backbone blocks supported by the UE 215 for a multi-block machine learning application, the UE 215 may transmit the first UE capability using different options. For example, the UE 215 may transmit a set of bits to indicate one overall UE capability level corresponding to a set of capabilities for the backbone block supported by the UE 215, where the set of capabilities are defined in a table for respective options for the set of bits. Table 1 below may illustrate possible sets of capabilities for each overall UE capability level corresponding to the respective options for the set of bits.

Table 1 may express an example of possible UE capability levels and the corresponding sets of capabilities and is not to be seen as an exhaustive list of all possible UE capabilities that the UE 215 can signal. Additionally, while the set of bits shown in Table 1 includes two (2) bits to represent each overall UE capability level, a greater number or a lesser number of bits may be used. In some examples, each option for the overall UE capability for the backbone block may correspond to a complexity level of the UE 215 (e.g., low-tier UEs may support less complex capabilities, medium-tier UEs may support more complex capabilities than the low-tier UEs, and high-tier UEs may support higher complex capabilities than the low-tier UEs and the medium-tier UEs).

TABLE 1
Signaling of Overall UE Capability Levels for Backbone Block

| | Indica- | Contents: {Backbone Type, Memory (Model |
|---|---|---|
| | tion | Size), Operations (Computing)} |
| | 00 | Not Supporting the Backbone Model |
| Low-Tier UE | 01 | {FC, <1 KB, <1k Flops} |
| Medium-Tier | 10 | {CNN + FC, <1 MB, <10k Flops} |
| UE | | |
| Premium UE | 11 | {CNN + FC + LSTM + Transformer, <10 |
| | | MB, <100k Flops}, or No Limitations |

Additionally or alternatively, the UE 215 may report the first UE capability for backbone blocks supported by the UE 215 for a multi-block machine learning application based on transmitting several bits to separately indicate UE capability levels for different aspects of the backbone block that are defined in a table. Table 2 may illustrate possible capabilities for each separate UE capability level corresponding to respective options for different sets of bits for each type of capability. For example, the UE 215 may transmit a first subset of bits to indicate machine learning model types supported by the UE 215 for the backbone block, a second subset of bits to indicate levels of model sizes supported by the UE 215, a third subset of bits to indicate levels of numbers of operations supported by the UE 215, and a fourth subset of bits for additional capability information or additional information from the UE 215.

As an example, the UE 215 may transmit “1100” for the first subset of bits, “0011” for the second subset of bits, and “1010” for the third subset of bits, where “1100” may be mapped to “supporting FC and CNN models, but not LSTM and transformer models,” “0011” may be mapped to one value such that the supported model size would not be larger than the one value, and “1010” may be mapped to one value as well such that the required operation of the model would not be larger than the value. Additionally, while the different sets of bits shown in Table 2 includes four (4) bits to represent each separate UE capability, a greater number or a lesser number of bits may be used.

TABLE 2
Signaling of Separate UE Capability Levels for Backbone Block

| | Indica- | |
|---|---|---|
| | tion | Contents |
| Bits on Model | 0000 | First Model Type(s) Supported |
| Type (e.g., | 0001 | Second Model Type(s) Supported |
| four (4) bits) | . . . | Additional Model Type(s) Supported |
| | 1111 | N-th Model Type(s) Supported |
| Bits on Model | 0000 | First Model Size(s) Supported |
| Size (e.g., four | 0001 | Second Model Size(s) Supported |
| (4) bits) | . . . | Additional Model Size(s) Supported |
| | 1111 | N-th Model Size(s) Supported |
| Bits on | 0000 | First Number(s) of Operations Supported |
| Operations | 0001 | Second Number(s) of Operations Supported |
| (e.g., four (4) | . . . | Additional Number(s) of Operations Supported |
| bits) | 1111 | N-th Number(s) of Operations Supported |
| Other Bits | XX | Additional Capabilities |

Additionally, as described previously, the machine learning capability information 220 may also include a second UE capability for a task-specific block, task-specific configurations, task-specific layer(s), or a task-specific model supported by the UE 215 for the multi-block machine learning application. For the task-specific blocks supported by the UE 215, the second UE capability reported by the UE 215 may indicate one or more tasks, one or more scenarios, or any combination thereof, supported by the UE 215. For the first UE capability corresponding to the backbone blocks supported by the UE 215, the capability on the backbone block may relate to (e.g., may be mainly related to) a UE tier and model complexity.

However, as mentioned previously, for one end-to-end machine learning model, backbone blocks may encompass most of the model size and operations, so the model complexity may not be an issue for the task-specific blocks supported by the UE 215. For example, the task-specific blocks may be designed to adapt to different tasks or scenarios, such that in the second UE capability reported by the UE 215 for task-specific blocks, the UE 215 may indicate which tasks or scenarios that the UE 215 can support for the multi-block machine learning application. That is, the UE 215 may indicate what tasks the UE 215 can support and/or may indicate what scenarios the UE 215 can support for the multi-block machine learning application. Table 3 may illustrate possible options for the UE 215 to report to indicate task-specific blocks that the UE 215 supports for the multi-block machine learning application and is not meant to represent an exhaustive list of all possible task-specific blocks supported by the UE 215. Additionally, while the set of bits shown in Table 3 includes two (2) bits to represent separate task-specific capabilities supported by the UE 215, a greater number or a lesser number of bits may be used.

TABLE 3
Signaling of UE Capability Levels for Task-Specific Block

| | Indication | Contents: {Functions, Scenarios} |
|---|---|---|
| UE Function and | 00 | {Positioning - indoor; mobility - high |
| Scenario | | Doppler} |
| Request | 01 | {Positioning - outdoor; mobility - low |
| | | Doppler} |
| | 10 | 00 + 01 |
| | 11 | Others |

As an example, there may be one backbone block for the multi-block machine learning application that uses the channel as an input. This one backbone block can support positioning and mobility and other specific tasks (e.g., multiple, different task-specific blocks), as well as supporting different low/high speed scenarios (e.g., 5 kilometers per hour (km/h) for pedestrian scenarios, 100 km/h for vehicle scenarios, etc.) and other scenarios. Accordingly, continuing with the example, as part of reporting the second UE capability, the UE 215 may report a capability that the UE 215 can support positioning for machine learning solutions in low-speed scenarios. Based on the capability reporting, the base station 205 may configure corresponding task-specific blocks for the multi-block machine learning application that the UE 215 supports rather than configuring all potential task-specific blocks. Subsequently, based on the first UE capability indicating supported backbone blocks and the second UE capability indicating supported task-specific blocks capability for the UE 215, the base station 205 may configure the multi-block machine learning application with corresponding backbone blocks and task-specific blocks for deployment to the UE 215.

With the first UE capability and the second UE capability, the UE 215 may separately indicate each capability to the base station 205 (e.g., as part of the machine learning capability information 220). Additionally or alternatively, rather than using separate indications for configurations of backbone and task-specific blocks supported by the UE 215, the UE 215 may report one general machine learning capability describing capabilities supported by the UE 215, such as machine learning structures, model sizes, numbers of operations, tasks, and scenarios supported by the UE 215. Subsequently, the base station 205 may map the general machine learning capability (e.g., an overall UE capability) into the backbone block capability and task-specific block capability for the UE 215. Additionally, the UE 215 may also still transmit one (1) bit to indicate that the UE 215 can support the multi-block machine learning application (e.g., a machine learning application that includes at least a backbone block and one or more task-specific blocks).

In some examples, the UE 215 may transmit the separate capability configurations (e.g., the first UE capability and the second UE capability) to enable flexible machine learning hardware implementations at the UE 215. For example, in wireless machine learning solutions, there may be 50 task and scenarios for a given machine learning application. With a backbone block being configured, those 50 models for the corresponding 50 tasks/scenarios may share two (2) or three (3) backbone blocks for all applications. If so, a backbone block or implementation may be implemented out of a task-specific block implementation, and the backbone block may be considered to be generally static or fixed. As such, the separate capability configurations may assist the UE 215 in being flexible for machine learning model implementation. Additionally or alternatively, if the UE 215 transmits the general machine learning capability, the base station 205 may work to accurately identify capability requirements of the UE 215 for determining and configuring backbone blocks and task-specific blocks supported by the UE 215.

When transmitting this general machine learning capability, the UE 215 may report machine learning capabilities including whether a backbone block is supported (e.g., one (1) bit), model sizes supported (e.g., some bits, where different bits are mapped to different thresholds), numbers of operations supported (e.g., some bits, where different bits are mapped to different thresholds), machine learning structure types supported (e.g., some bits to indicate the machine learning structures supported from a list, such as CNN, FC, LSTM, transformer, etc.), and conditions/tasks/scenarios supported (e.g., some bits to indicate task/scenarios supported by the UE 215 from a list). Subsequently, the base station 205 may roughly estimate the capability for the backbone and task-specific blocks and transmit an indication of a configuration for the multi-block machine learning application via the control signaling 225 based on the estimated capabilities for the UE 215.

That is, the base station 205 may configure the UE 215 with an end-to-end multi-block machine learning application by configuring the UE 215 with one or more backbone blocks and one or more task-specific blocks based on the machine learning capability information 220. For example, base station 205 may transmit to UE 215 a backbone block of a multi-block machine learning application and a task-specific block for the multi-block machine learning application. A block may include the structure for an associated model as well as corresponding parameters sets (e.g., parameter sets that correspond to the layers of the model). For example, each block may include one or more layers corresponding to the different types of blocks (e.g., backbone block, task-specific block, etc.), such as one or more CNN layers (e.g., convolutional layers), pooling layers, FC layers, or others. The base station 205 may transmit configurations for the backbone block and the task-specific block in the same message or different messages.

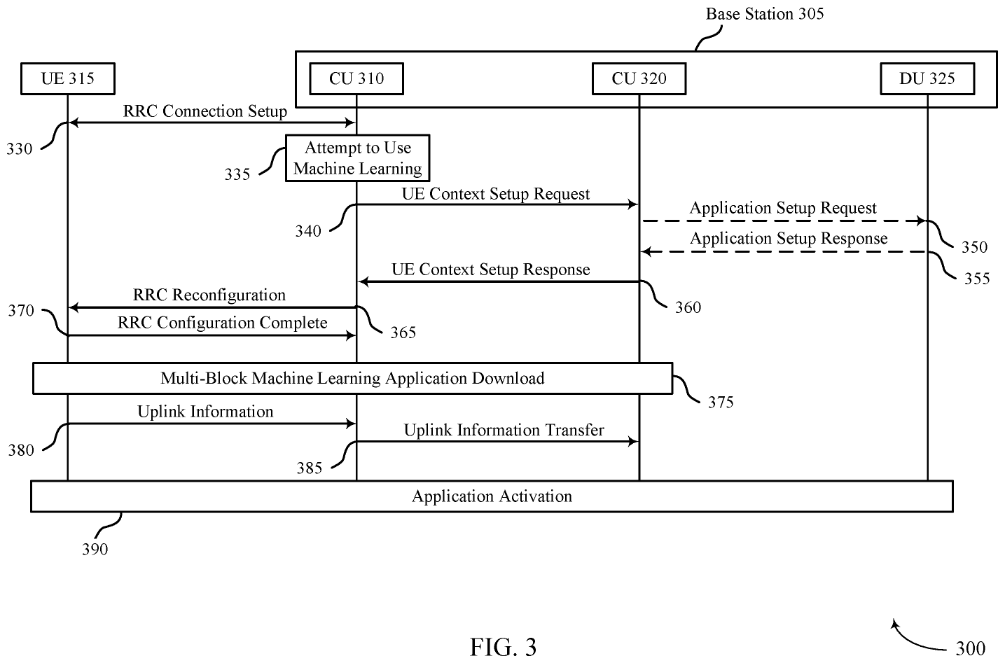

FIG. 3 illustrates an example of a process flow 300 that supports a capability indication for a multi-block machine learning model in accordance with aspects of the present disclosure. The process flow 300 may be implemented by a base station 305 and a UE 315, which may be examples of a base station and a UE as described herein. Base station 305 may include CU 310, CU 320 (which may also be referred to as CU−XP, an application manager, or a model manager), and DU 325. Process flow 300 may illustrate operations of the base station 305 and the UE 315 for configuring an application inference. The operations may enable the UE 315 to efficiently update machine learning applications.

At 330, the UE 315 and the base station 305 (e.g., via CU 310) may engage in an RRC connection setup procedure. During the RRC connection setup procedure, the UE 315 may report the radio capabilities and machine learning capabilities of the UE 315 (e.g., as described herein). At 335, CU 310 may attempt to use machine learning for one or more operations or functions. At 340, CU 310 may communicate a UE context setup request to CU 320. In some examples, the UE context setup request may indicate the machine learning capabilities of the UE 315. In some examples, the UE context setup request may indicate a list of requested neural network function identifiers, which may be referred to as NNF-IDs and which may identify the function achieved by a neural network. For example, a neural network may achieve a function: Y=F(X), where F may be identified by a standardized Neural network identifier NNF-ID, X may refer to a standardized input to a neural network, and Y may refer to a standardized out of the neural network. At 345, CU 320 may communicate an application setup request to DU 325.

At 350, CU 320 may communicate an application setup request to DU 325. At 355, DU 325 may communicate an application setup response to CU 320. At 360, CU 320 may communicate a UE context setup response to CU 310. In some examples, the UE context setup response may indicate a list of accepted NNF-IDs. In some examples, the UE context setup response may indicate or include a machine learning container. At 365, base station 305 may (e.g., via CU 310) transmit an RRC reconfiguration message to UE 315. The RRC reconfiguration message may be an RRC message. In some examples, the RRC reconfiguration message may indicate the list of accepted NNF-IDs. In some examples, the RRC reconfiguration message may indicate or include the machine learning container. At 370, UE 315 may transmit an RRC configuration complete message to the base station 305 (e.g., to CU 310).

At 375, the UE 315 and the base station 305 (e.g., via CU 310 and CU 320) may engage in a machine learning application download operation. For example, the base station 305 may transmit a multi-block machine learning application and a configuration for the multi-block machine learning application to the UE 315 (e.g., a model structure and weight set). The multi-block machine learning application, the configuration, or both, may be conveyed in one or more RRC messages (e.g., a single RRC message to transmit configurations for a backbone block and multiple task-specific blocks, a first RRC message to transmit a configuration for a backbone block and may use a second RRC message to transmit a configuration for a task-specific block, or a different option). As described herein, the base station 305 may configure the multi-block machine learning application, including the backbone block and the task-specific block(s), based on machine learning capabilities of the UE 315 signaled at 330.

The multi-block machine learning application downloaded at 375 may be configured for one task, mapped to a specific set of conditions, or both. For example, the multi-block machine learning model may have a cell-based configuration, meaning that there is one multi-block machine learning application per cell. As another example, the multi-block machine learning application may have an operation-based or task-based configuration, meaning that there is one multi-block machine learning application per operation or per task (where a task may be a sub-operation for an operation). As another example, the multi-block machine learning application may have a scenario-based configuration, meaning that there is one multi-block machine learning application per scenario (e.g., set of conditions). As another example, the multi-block machine learning application may have a time-based configuration, meaning that there is one multi-block machine learning application per time stamp.

At 380, the UE 315 may transmit machine learning uplink information to the base station 305 (e.g., to CU 310). In some examples, the message that conveys the machine learning uplink information may also indicate or include the machine learning container. Additionally or alternatively, the message at 380 may indicate that a particular NNF is ready. At 385, CU 310 may communicate a machine learning uplink transfer message to CU 320. In some examples, the machine learning uplink transfer message may indicate or include the machine learning container. At 390, the UE 315 and the base station 305 (e.g., via CU 310, CU 320, and DU 325) may engage in an activation procedure for the multi-block machine learning application downloaded at 375.

Thus, the UE 315 and the base station 305 may build a connection via the operations between 330 and 370 (inclusive), perform a machine learning application download at 375, and activate the machine learning application via the operations between 380 and 390 (inclusive). Application activation may refer to use or implementation of a machine learning application and may also be referred to as making or configuring a machine learning inference.

Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

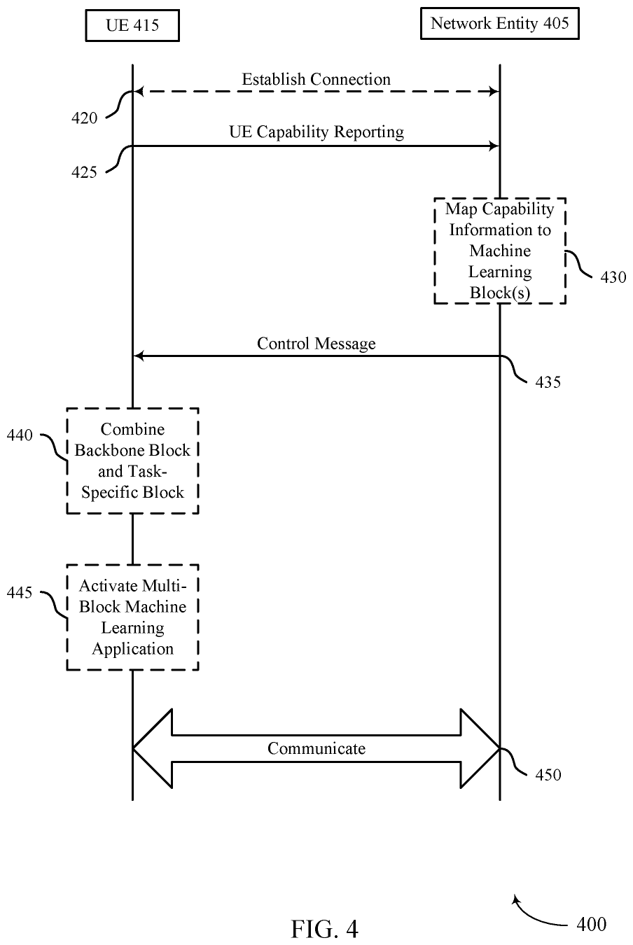

FIG. 4 illustrates an example of a process flow 400 that supports a capability indication for a multi-block machine learning model in accordance with aspects of the present disclosure. The process flow 400 may be implemented by a network entity 405 and a UE 415, which may be examples of a base station 105 and a UE 115, respectively, as described herein. The process flow 400 may illustrate operations of the network entity 405 and the UE 415 that enable the UE 415 to indicate machine learning capabilities for the network entity 405 to efficiently configure and signal a machine learning model for the UE 415 to use. In some examples, aspects of the process flow 400 may be combined with aspects of the process flow 300.

In the following description of process flow 400, the operations between the network entity 405 and the UE 415 may be performed in different orders or at different times. Certain operations may also be left out of process flow 400, or other operations may be added to process flow 400. It is to be understood that while the network entity 405 and the UE 415 are shown performing a number of the operations of process flow 400, any device or wireless device may perform the operations shown.

At 420, the UE 415 and the network entity 405 may establish a connection. In some examples, the UE 415 and the network entity 405 may establish the connection as described with reference to FIG. 3.

At 425, the UE 415 may transmit, to the network entity 405 (e.g., as part of a base station 105), an indication identifying a first UE capability for a backbone block of a multi-block machine learning application and a second UE capability for a task-specific block of the multi-block machine learning application. Additionally, the UE 415 may transmit, to the network entity 405, an indication that the UE 415 supports the multi-block machine learning application. In some examples, the first UE capability may include an indication of neural network types for the backbone block supported by the UE (e.g., CNN, FC, LSTM, transformer, etc.), machine learning model size levels for the backbone block supported by the UE (e.g., <1 KB, <1 MB, <10 MB, etc.), operation levels for the backbone block supported by the UE (e.g., <1K flops, <10K flops, <100K flops, etc.), or a combination thereof. Additionally or alternatively, the second UE capability may include an indication of tasks, scenarios, or a combination thereof, that the UE 415 supports for the task-specific block. While described herein as a backbone block and task-specific block, the backbone block and task-specific block may be also referred to as backbone/task-specific models or layers.

In some examples, as part of the first UE capability, the UE 415 may transmit a first indicator identifying, for the UE 415, one capability level of a set of capability levels associated with the backbone block, the one capability level identifying the first UE capability for the backbone block (e.g., as shown and described with reference to Table 1). Additionally or alternatively, the UE 415 may transmit a set of indicators that identify multiple capability parameters of the UE 415, where the multiple capability parameters collectively identify the first UE capability for the backbone block and each indicator of the set of indicators corresponds to a respective capability parameter of the multiple capability parameters (e.g., as shown and described with reference to Table 2).

In some examples, as part of the second UE capability, the UE 415 may transmit a second indicator identifying a set of tasks that the UE 415 supports for the task-specific block of the multi-block machine learning application, scenarios the UE 415 supports for the task-specific block of the multi-block machine learning application, or a combination thereof (e.g., as shown and described with reference to Table 3).

Additionally or alternatively, rather than transmitting separate indications of the UE machine learning capabilities, UE 415 may transmit an indicator of a machine learning capability of the UE 415, where the machine learning capability is associated with a combination of the backbone block and the task-specific block supported by the UE 415. For example, the machine learning capability of the UE 415 may include an indicator that the UE 415 supports the multi-block machine learning application and a set of indicators identifying the machine learning capability associated with the combination of the backbone block and the task-specific block. Additionally or alternatively, the machine learning capability of the UE 415 may include, for the combination of the backbone block and the task-specific block, a supported size, a supported operation, a machine learning structure type, a supported condition, a supported task, a supported scenario, or a combination thereof for the UE 415.

At 430, upon receiving an indicator of a machine learning capability of the UE 415, the network entity 405 may determine or map the first UE capability for the backbone block and the second UE capability for the task-specific block based on the machine learning capability that is associated with the combination of the backbone block and the task-specific block.

At 435, the UE 415 may receive, from the network entity 405, control signaling identifying a configuration for the multi-block machine learning application of the UE 415 at least in part in response to the indication identifying the first UE capability and the second UE capability. In some examples, the control signaling configuring the multi-block machine learning application of the UE 415 may be received in response to the indication that the UE 415 supports the multi-block machine learning application.

At 440, the UE 415 may combine the backbone block with one of the task-specific blocks to build an end-to-end multi-block machine learning application. For example, the UE 415 may combine the backbone block with a first task-specific block indicated in the control signaling. When combined with the backbone block, the first task-specific block may operate on one or more intermediate outputs from the backbone block.

At 445, the UE 415 may activate the first end-to-end multi-block machine learning application that includes the combination of the backbone block and the first task-specific block. For example, the UE 415 may use the first multi-block machine learning application to perform one or more operations.

At 450, the UE 415 may communicate with the network entity 405 or an additional wireless device using the multi-block machine learning application configured in accordance with the control signaling. For example, the UE 415 may use the first multi-block machine learning application to process one or more signals received from the network entity 405 to generate one or more outputs. Thus, the UE 415 may communicate a message with the network entity 405 (or additional wireless device) based on one or more outputs from the first task-specific block (which in turn may be based on the one or more intermediate outputs from the backbone block). To illustrate, the UE 415 may select a beam direction for communicating with the network entity 405 based on the one or more outputs (e.g., angle estimations) from the first task-specific block. As another example, the UE 415 may use a precoder for communicating with the network entity 405 that is based on one or more precoder parameters output from the first task-specific block.

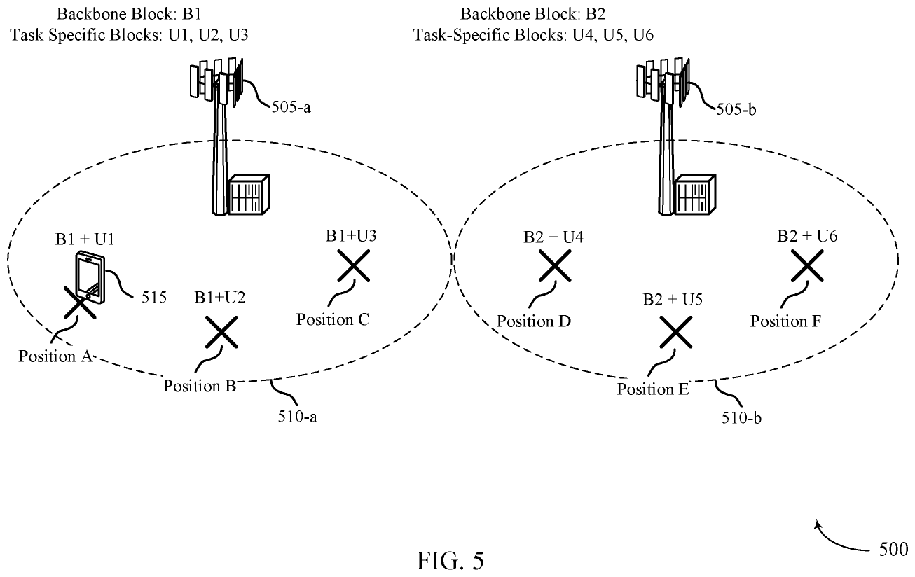

FIG. 5 illustrates an example of a wireless communications system 500 that supports a capability indication for a multi-block machine learning model in accordance with aspects of the present disclosure. The wireless communications system 500 may include a base station 505-a, a base station 505-b, and a UE 515, which may be examples of corresponding devices as described herein. In the wireless communications system 500, the UE 515 and the base stations 505 may implement aspects described herein for enabling a determination of backbone blocks and task-specific blocks to form multi-block machine learning applications.

Base station 505-a may be associated with a first cell or a first cell group that has coverage area 510-a. Base station 505-b may be associated with a second cell or a second cell group that has coverage area 510-b. Base station 505-a may support a first backbone block (denoted B1) and base station 505-b may support a second backbone block (denoted B2). The first backbone block may support a first set of channel conditions (e.g., Doppler conditions, channel type) and the second backbone block may support a second set of channel conditions. For example, the first backbone block may support high Doppler conditions and the second backbone block may be configured for low Doppler conditions.

Upon accessing the cell (or the cell group) associated with base station 505-a, the UE 515 may receive a control message that includes, indicates, or configures (or a combination thereof) the first backbone block. The UE 515 may also receive another control message that includes, indicates, or configures (or a combination thereof) a first task-specific block (denoted U1) that is compatible with the first backbone block. The first task-specific block may be configured for use at Position A (e.g., the first task-specific model may be location-based). The UE 515 may combine the first task-specific block with the first backbone block to form a multi-block machine learning application and may use the multi-block machine learning application for communications with base station 505-a.

If the UE 515 moves to Position B, the UE 515 may receive a control message that includes, indicates, or configures (or a combination thereof) a second task-specific block (denoted U2) that is compatible with the first backbone block and that is configured for use at Position B. Similarly, if the UE 515 moves to Position C, the UE 515 may receive a control message that includes, indicates, or configures (or a combination thereof) a third task-specific block (denoted U3) that is compatible with the first backbone block and that is configured for use at Position C. The control messages configuring task-specific blocks may be transmitted by base station 505-a in response to a request from the UE 515 or autonomously (e.g., independent of a request from the UE 515).

Upon accessing the cell (or the cell group) associated with base station 505-b, the UE 515 may receive a control message that includes, indicates, or configures the second backbone block. The UE 515 may also receive another control message that includes, indicates, or configures (or a combination thereof) a fourth task-specific block (denoted U4) that is compatible with the second backbone block. The fourth task-specific block may be configured for use at Position D. The UE 515 may combine the fourth task-specific block with the second backbone block to form a multi-block machine learning application and may use the multi-block machine learning application to for communications with base station 505-b.

If the UE 515 moves to Position E, the UE 515 may receive a control message that includes, indicates, or configures (or a combination thereof) a fifth task-specific block (denoted U5) that is compatible with the second backbone block and that is configured for use at Position E. Similarly, if the UE 515 moves to Position F, the UE 515 may receive a control message that includes, indicates, or configures (or a combination thereof) a sixth task-specific block (denoted U6) that is compatible with the second backbone block and that is configured for use at Position D. The control messages configuring task-specific blocks may be transmitted by base station 505-b in response to a request from the UE 515 or autonomously (e.g., independent of a request from the UE 515).

Although describe with reference to a change in conditions (e.g., channel conditions, locations), the UE 515 may be configured with task-specific blocks based on other triggers, such as a change in tasks. Although describe with reference to a change in cells (or cell groups), the UE 515 may be configured with backbone blocks based on other triggers, such as a change in conditions. Additionally, the different backbone blocks and task-specific blocks may be determined by one or both base stations 505 (e.g., an individual base station 505 may determine a configuration for a given backbone block and task-specific block for the UE 515 to use and signal the determined blocks to the other base station 505 via a backhaul connection, or each base station 505 may determine corresponding block for the UE 515 to use for multi-block machine learning applications with each base station 505). As described herein, the base stations 505 may determine the backbone block and task-specific block for the UE 515 to use based on UE capability information transmitted by the UE 515 indicating machine learning capabilities that the UE 515 supports for multi-block machine learning applications.

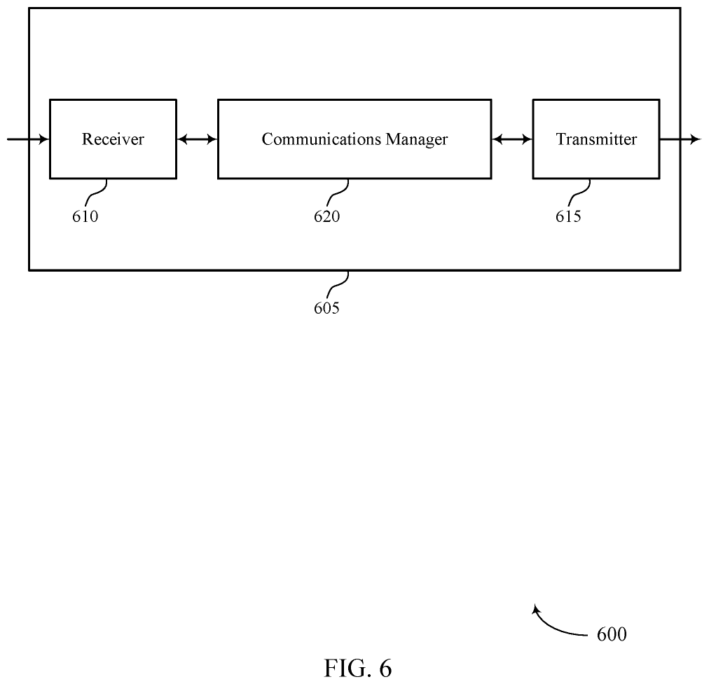

FIG. 6 shows a block diagram 600 of a device 605 that supports capability indication for a multi-block machine learning model in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to capability indication for a multi-block machine learning model). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to capability indication for a multi-block machine learning model). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of capability indication for a multi-block machine learning model as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for transmitting, to a base station, an indication identifying a first UE capability for a backbone block of a multi-block machine learning application and a second UE capability for a task-specific block of the multi-block machine learning application. The communications manager 620 may be configured as or otherwise support a means for receiving, from the base station, control signaling identifying a configuration for the multi-block machine learning application of the UE at least in part in response to the indication identifying the first UE capability and the second UE capability. The communications manager 620 may be configured as or otherwise support a means for communicating with the base station or a wireless device using the multi-block machine learning application configured in accordance with the control signaling.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, and more efficient utilization of communication resources.

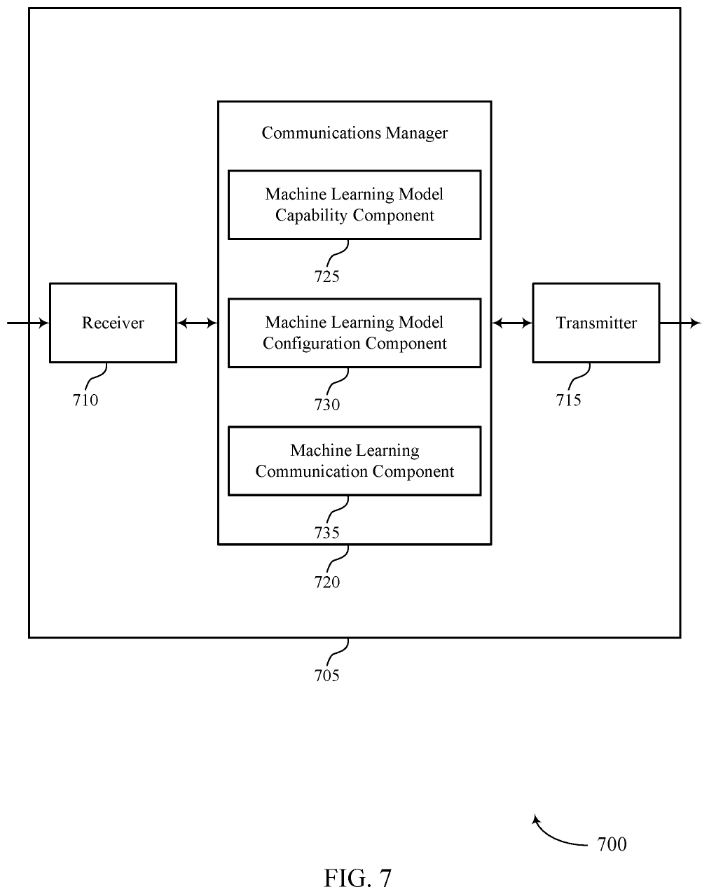

FIG. 7 shows a block diagram 700 of a device 705 that supports capability indication for a multi-block machine learning model in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to capability indication for a multi-block machine learning model). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to capability indication for a multi-block machine learning model). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of capability indication for a multi-block machine learning model as described herein. For example, the communications manager 720 may include a machine learning model capability component 725, a machine learning model configuration component 730, a machine learning communication component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The machine learning model capability component 725 may be configured as or otherwise support a means for transmitting, to a base station, an indication identifying a first UE capability for a backbone block of a multi-block machine learning application and a second UE capability for a task-specific block of the multi-block machine learning application. The machine learning model configuration component 730 may be configured as or otherwise support a means for receiving, from the base station, control signaling identifying a configuration for the multi-block machine learning application of the UE at least in part in response to the indication identifying the first UE capability and the second UE capability. The machine learning communication component 735 may be configured as or otherwise support a means for communicating with the base station or a wireless device using the multi-block machine learning application configured in accordance with the control signaling.

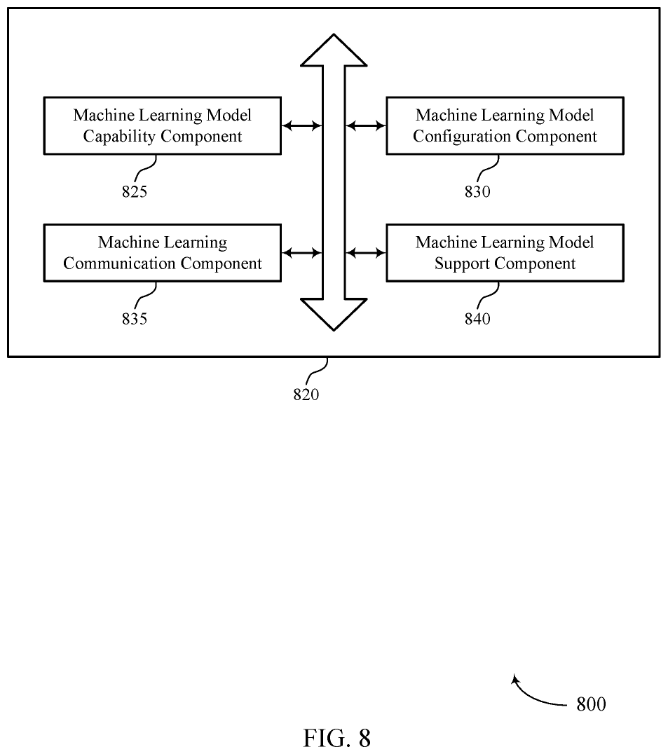

FIG. 8 shows a block diagram 800 of a communications manager 820 that supports capability indication for a multi-block machine learning model in accordance with aspects of the present disclosure. The communications manager 820 may be an example of aspects of a communications manager 620, a communications manager 720, or both, as described herein. The communications manager 820, or various components thereof, may be an example of means for performing various aspects of capability indication for a multi-block machine learning model as described herein. For example, the communications manager 820 may include a machine learning model capability component 825, a machine learning model configuration component 830, a machine learning communication component 835, a machine learning model support component 840, or any combination thereof. Each of these components may communicate, directly or indirectly, with one another (e.g., via one or more buses).

The communications manager 820 may support wireless communications at a UE in accordance with examples as disclosed herein. The machine learning model capability component 825 may be configured as or otherwise support a means for transmitting, to a base station, an indication identifying a first UE capability for a backbone block of a multi-block machine learning application and a second UE capability for a task-specific block of the multi-block machine learning application. The machine learning model configuration component 830 may be configured as or otherwise support a means for receiving, from the base station, control signaling identifying a configuration for the multi-block machine learning application of the UE at least in part in response to the indication identifying the first UE capability and the second UE capability. The machine learning communication component 835 may be configured as or otherwise support a means for communicating with the base station or a wireless device using the multi-block machine learning application configured in accordance with the control signaling.

In some examples, the machine learning model support component 840 may be configured as or otherwise support a means for transmitting, to the base station, an indication that the UE supports the multi-block machine learning application, where the control signaling configuring the multi-block machine learning application of the UE is received in response to the indication that the UE supports the multi-block machine learning application.

In some examples, to support transmitting the indication identifying the first UE capability and the second UE capability, the machine learning model capability component 825 may be configured as or otherwise support a means for transmitting a first indicator identifying, for the UE, one capability level of a set of capability levels associated with the backbone block, the one capability level identifying the first UE capability for the backbone block.

In some examples, to support transmitting the indication identifying the first UE capability and the second UE capability, the machine learning model capability component 825 may be configured as or otherwise support a means for transmitting a set of multiple indicators that identify a set of multiple capability parameters, the set of multiple capability parameters collectively identifying the first UE capability for the backbone block, and each indicator of the set of multiple indicators corresponding to a respective capability parameter of the set of multiple capability parameters.

In some examples, to support transmitting the indication identifying the first UE capability and the second UE capability, the machine learning model capability component 825 may be configured as or otherwise support a means for transmitting a second indicator identifying a set of tasks that the UE supports for the task-specific block of the multi-block machine learning application, scenarios the UE supports for the task-specific block of the multi-block machine learning application, or a combination thereof.

In some examples, to support transmitting the indication identifying the first UE capability and the second UE capability, the machine learning model capability component 825 may be configured as or otherwise support a means for transmitting an indicator of a machine learning capability of the UE, where the machine learning capability is associated with a combination of the backbone block and the task-specific block.

In some examples, the machine learning capability of the UE includes an indicator that the UE supports the multi-block machine learning application and a set of indicators identifying the machine learning capability associated with the combination of the backbone block and the task-specific block.

In some examples, the machine learning capability of the UE includes, for the combination of the backbone block and the task-specific block, a supported size, a supported operation, a machine learning structure type, a supported condition, a supported task, a supported scenario, or a combination thereof.

In some examples, to support indication identifying the first UE capability and the second UE capability, the machine learning model capability component 825 may be configured as or otherwise support a means for an indication of neural network types for the backbone block supported by the UE, machine learning model size levels for the backbone block supported by the UE, operation levels for the backbone block supported by the UE, or a combination thereof. In some examples, to support indication identifying the first UE capability and the second UE capability, the machine learning model capability component 825 may be configured as or otherwise support a means for an indication of tasks, scenarios, or a combination thereof, that the UE supports for the task-specific block.

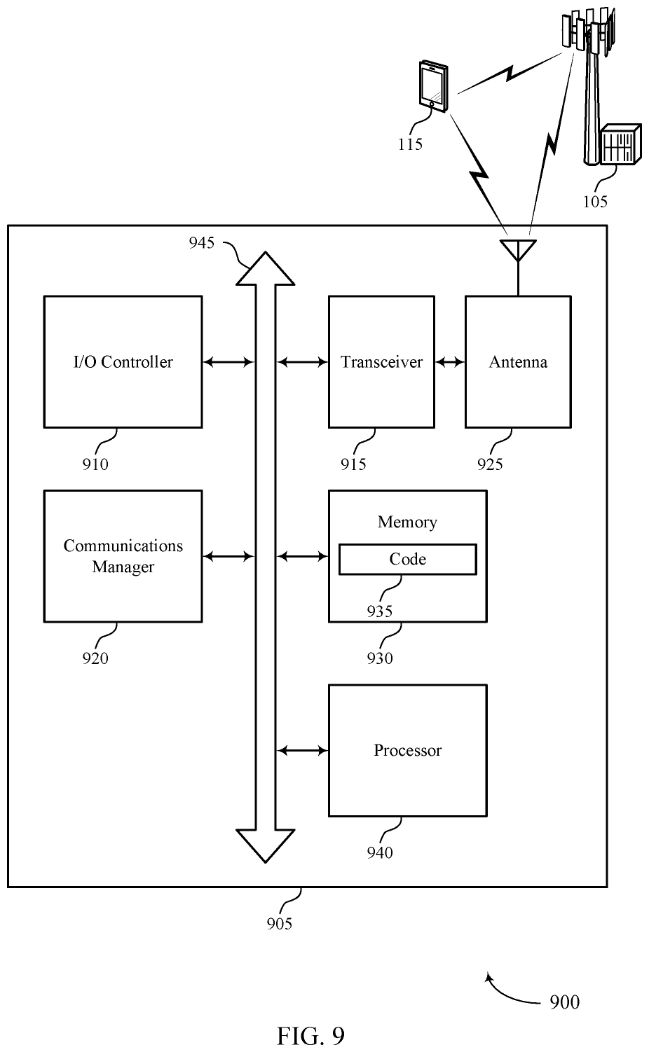

FIG. 9 shows a diagram of a system 900 including a device 905 that supports capability indication for a multi-block machine learning model in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting capability indication for a multi-block machine learning model). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting, to a base station, an indication identifying a first UE capability for a backbone block of a multi-block machine learning application and a second UE capability for a task-specific block of the multi-block machine learning application. The communications manager 920 may be configured as or otherwise support a means for receiving, from the base station, control signaling identifying a configuration for the multi-block machine learning application of the UE at least in part in response to the indication identifying the first UE capability and the second UE capability. The communications manager 920 may be configured as or otherwise support a means for communicating with the base station or a wireless device using the multi-block machine learning application configured in accordance with the control signaling.

By including or configuring the communications manager 920 in accordance with examples as described herein, the device 905 may support techniques for improved communication reliability, reduced latency, reduced power consumption, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of capability indication for a multi-block machine learning model as described herein, or the processor 940 and the memory 930 may be otherwise configured to perform or support such operations.

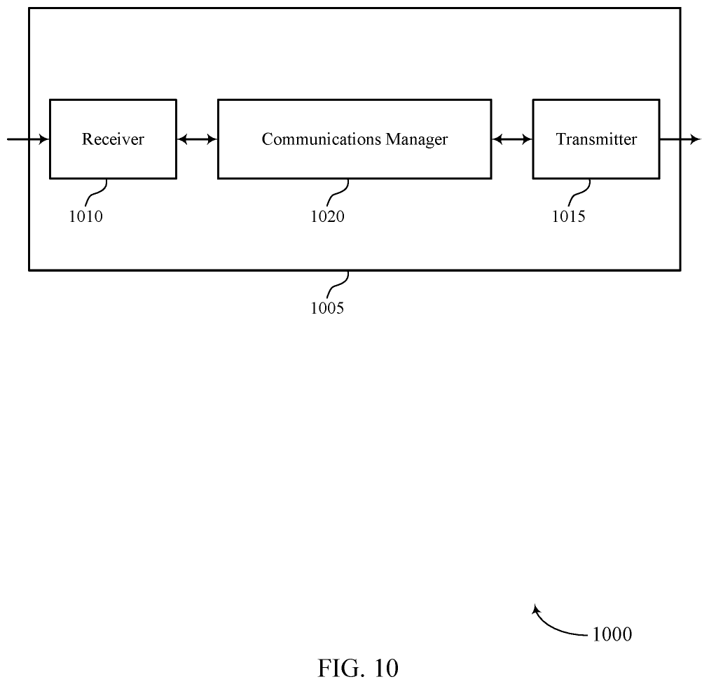

FIG. 10 shows a block diagram 1000 of a device 1005 that supports capability indication for a multi-block machine learning model in accordance with aspects of the present disclosure. The device 1005 may be an example of aspects of a network entity as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to capability indication for a multi-block machine learning model). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to capability indication for a multi-block machine learning model). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of capability indication for a multi-block machine learning model as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a network entity in accordance with examples as disclosed herein. For example, the communications manager 1020 may be configured as or otherwise support a means for receiving, from a UE, an indication identifying a first UE capability for a backbone block of a multi-block machine learning application and a second UE capability for a task-specific block of the multi-block machine learning application. The communications manager 1020 may be configured as or otherwise support a means for transmitting, to the UE in response to the first UE capability and the second UE capability, control signaling to configure the multi-block machine learning application of the UE. The communications manager 1020 may be configured as or otherwise support a means for communicating with the UE based on the control signaling.

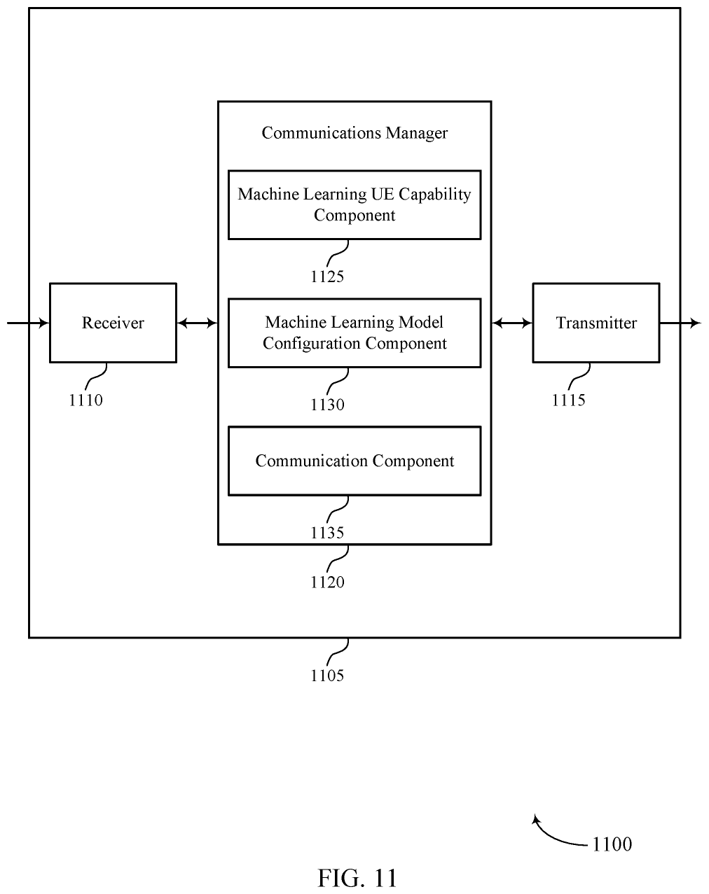

FIG. 11 shows a block diagram 1100 of a device 1105 that supports capability indication for a multi-block machine learning model in accordance with aspects of the present disclosure. The device 1105 may be an example of aspects of a device 1005 or a network entity as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to capability indication for a multi-block machine learning model). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to capability indication for a multi-block machine learning model). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of capability indication for a multi-block machine learning model as described herein. For example, the communications manager 1120 may include a machine learning UE capability component 1125, a machine learning model configuration component 1130, a communication component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a network entity in accordance with examples as disclosed herein. The machine learning UE capability component 1125 may be configured as or otherwise support a means for receiving, from a UE, an indication identifying a first UE capability for a backbone block of a multi-block machine learning application and a second UE capability for a task-specific block of the multi-block machine learning application. The machine learning model configuration component 1130 may be configured as or otherwise support a means for transmitting, to the UE in response to the first UE capability and the second UE capability, control signaling to configure the multi-block machine learning application of the UE. The communication component 1135 may be configured as or otherwise support a means for communicating with the UE based on the control signaling.

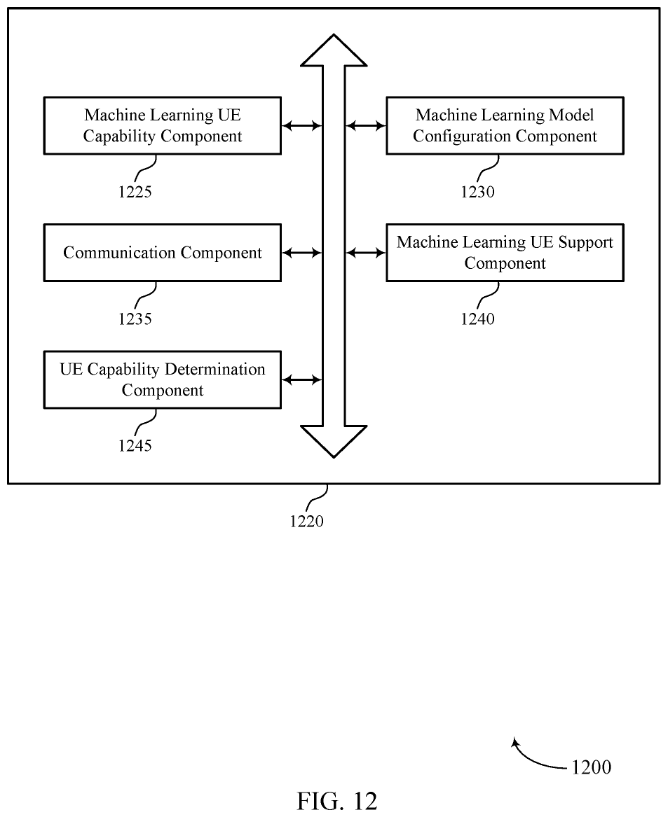

FIG. 12 shows a block diagram 1200 of a communications manager 1220 that supports capability indication for a multi-block machine learning model in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of capability indication for a multi-block machine learning model as described herein. For example, the communications manager 1220 may include a machine learning UE capability component 1225, a machine learning model configuration component 1230, a communication component 1235, a machine learning UE support component 1240, a UE capability determination component 1245, or any combination thereof. Each of these components may communicate, directly or indirectly, with one another (e.g., via one or more buses).

The communications manager 1220 may support wireless communications at a network entity in accordance with examples as disclosed herein. The machine learning UE capability component 1225 may be configured as or otherwise support a means for receiving, from a UE, an indication identifying a first UE capability for a backbone block of a multi-block machine learning application and a second UE capability for a task-specific block of the multi-block machine learning application. The machine learning model configuration component 1230 may be configured as or otherwise support a means for transmitting, to the UE in response to the first UE capability and the second UE capability, control signaling to configure the multi-block machine learning application of the UE. The communication component 1235 may be configured as or otherwise support a means for communicating with the UE based on the control signaling.

In some examples, the machine learning UE support component 1240 may be configured as or otherwise support a means for receiving, from the UE, an indication that the UE supports the multi-block machine learning application, where the control signaling configuring the multi-block machine learning application of the UE is transmitted based on the UE supporting the multi-block machine learning application.

In some examples, to support receiving the indication identifying the first UE capability and the second UE capability, the machine learning UE capability component 1225 may be configured as or otherwise support a means for receiving a first indicator identifying, for the UE, one capability level of a set of capability levels associated with the backbone block, the one capability level identifying the first UE capability for the backbone block.

In some examples, to support receiving the indication identifying the first UE capability and the second UE capability, the machine learning UE capability component 1225 may be configured as or otherwise support a means for receiving a set of multiple indicators that identify a set of multiple capability parameters, the set of multiple capability parameters collectively identifying the first UE capability for the backbone block, and each indicator of the set of multiple indicators corresponding to a respective capability parameter of the set of multiple capability parameters.

In some examples, to support receiving the indication identifying the first UE capability and the second UE capability, the machine learning UE capability component 1225 may be configured as or otherwise support a means for receiving a second indicator identifying a set of tasks that the UE supports for the task-specific block of the multi-block machine learning application, scenarios the UE supports for the task-specific block of the multi-block machine learning application, or a combination thereof.

In some examples, to support receiving the indication identifying the first UE capability and the second UE capability, the UE capability determination component 1245 may be configured as or otherwise support a means for receiving an indicator of a machine learning capability of the UE, where the machine learning capability is associated with a combination of the backbone block and the task-specific block. In some examples, to support receiving the indication identifying the first UE capability and the second UE capability, the UE capability determination component 1245 may be configured as or otherwise support a means for determining the first UE capability for the backbone block and the second UE capability for the task-specific block based on the machine learning capability that is associated with the combination of the backbone block and the task-specific block.

In some examples, the machine learning capability of the UE includes an indicator that the UE supports the multi-block machine learning application and a set of indicators identifying the machine learning capability associated with the combination of the backbone block and the task-specific block.

In some examples, the machine learning capability of the UE includes, for the combination of the backbone block and the task-specific block, a supported size, a supported operation, a machine learning structure type, a supported condition, a supported task, a supported scenario, or a combination thereof.

In some examples, to support indication identifying the first UE capability and the second UE capability, the machine learning UE capability component 1225 may be configured as or otherwise support a means for an indication of neural network types for the backbone block supported by the UE, machine learning model size levels for the backbone block supported by the UE, operation levels for the backbone block supported by the UE, or a combination thereof. In some examples, to support indication identifying the first UE capability and the second UE capability, the machine learning UE capability component 1225 may be configured as or otherwise support a means for an indication of tasks, scenarios, or a combination thereof, that the UE supports for the task-specific block.

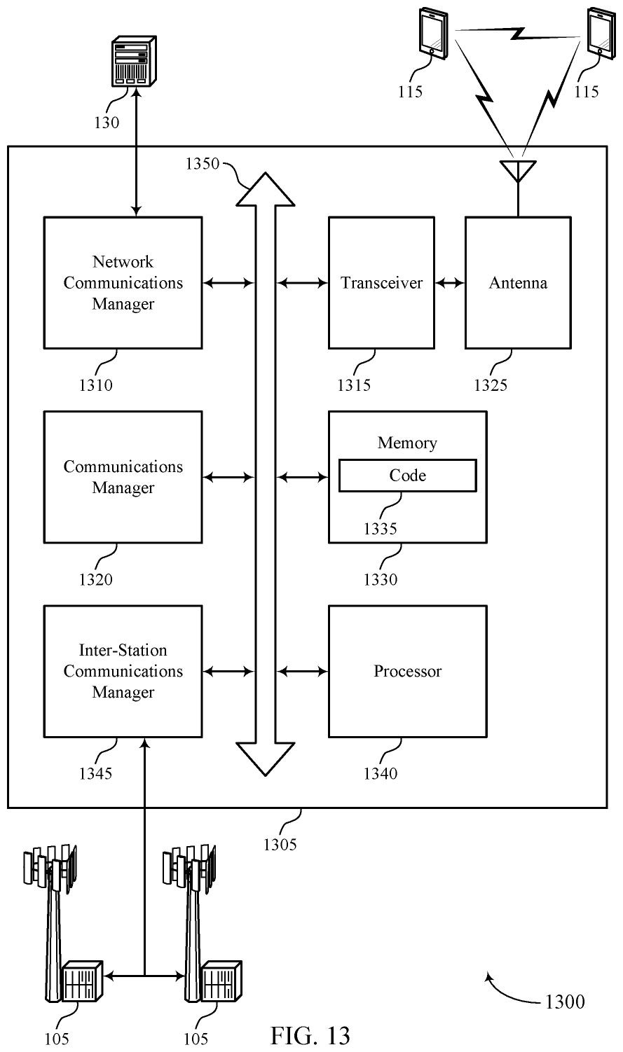

FIG. 13 shows a diagram of a system 1300 including a device 1305 that supports capability indication for a multi-block machine learning model in accordance with aspects of the present disclosure. The device 1305 may be an example of or include the components of a device 1005, a device 1105, or a network entity as described herein. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting capability indication for a multi-block machine learning model). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a network entity in accordance with examples as disclosed herein. For example, the communications manager 1320 may be configured as or otherwise support a means for receiving, from a UE, an indication identifying a first UE capability for a backbone block of a multi-block machine learning application and a second UE capability for a task-specific block of the multi-block machine learning application. The communications manager 1320 may be configured as or otherwise support a means for transmitting, to the UE in response to the first UE capability and the second UE capability, control signaling to configure the multi-block machine learning application of the UE. The communications manager 1320 may be configured as or otherwise support a means for communicating with the UE based on the control signaling.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of capability indication for a multi-block machine learning model as described herein, or the processor 1340 and the memory 1330 may be otherwise configured to perform or support such operations.

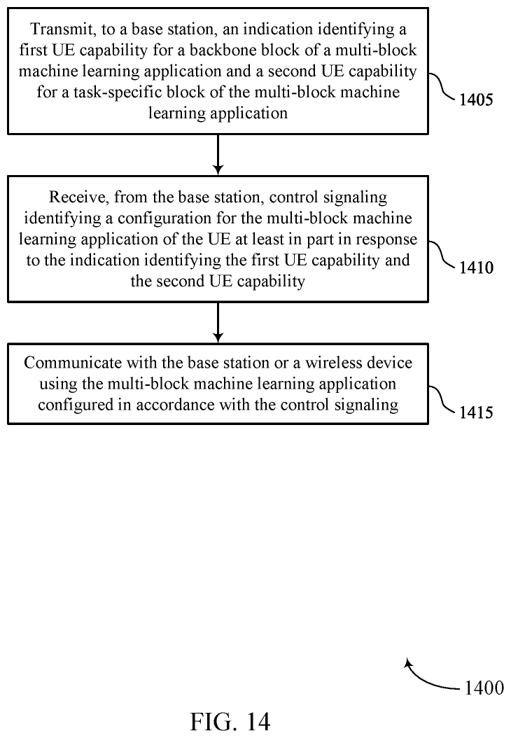

FIG. 14 shows a flowchart illustrating a method 1400 that supports capability indication for a multi-block machine learning model in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include transmitting, to a base station, an indication identifying a first UE capability for a backbone block of a multi-block machine learning application and a second UE capability for a task-specific block of the multi-block machine learning application. The operations of 1405 may be performed in accordance with examples as disclosed herein. In some examples, aspects of the operations of 1405 may be performed by a machine learning model capability component 825 as described with reference to FIG. 8.

At 1410, the method may include receiving, from the base station, control signaling identifying a configuration for the multi-block machine learning application of the UE at least in part in response to the indication identifying the first UE capability and the second UE capability. The operations of 1410 may be performed in accordance with examples as disclosed herein. In some examples, aspects of the operations of 1410 may be performed by a machine learning model configuration component 830 as described with reference to FIG. 8.

At 1415, the method may include communicating with the base station or a wireless device using the multi-block machine learning application configured in accordance with the control signaling. The operations of 1415 may be performed in accordance with examples as disclosed herein. In some examples, aspects of the operations of 1415 may be performed by a machine learning communication component 835 as described with reference to FIG. 8.

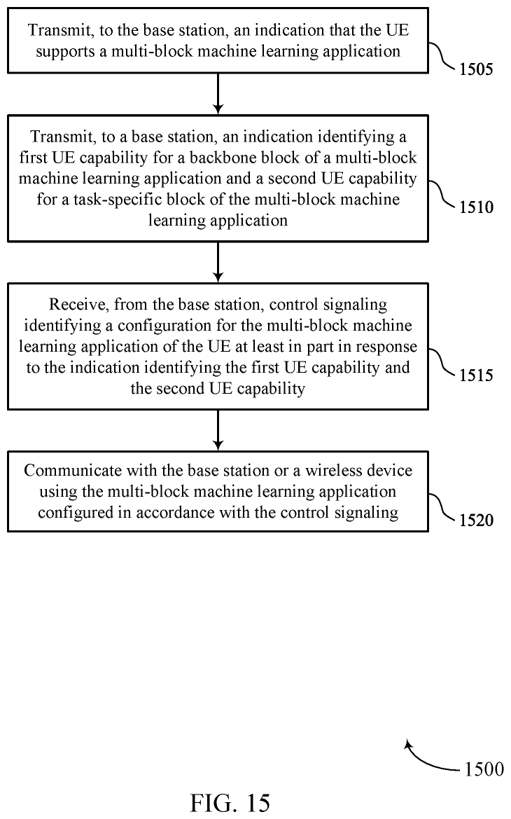

FIG. 15 shows a flowchart illustrating a method 1500 that supports capability indication for a multi-block machine learning model in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include transmitting, to the base station, an indication that the UE supports the multi-block machine learning application. The operations of 1505 may be performed in accordance with examples as disclosed herein. In some examples, aspects of the operations of 1505 may be performed by a machine learning model support component 840 as described with reference to FIG. 8.

At 1510, the method may include transmitting, to a base station, an indication identifying a first UE capability for a backbone block of a multi-block machine learning application and a second UE capability for a task-specific block of the multi-block machine learning application. The operations of 1510 may be performed in accordance with examples as disclosed herein. In some examples, aspects of the operations of 1510 may be performed by a machine learning model capability component 825 as described with reference to FIG. 8.

At 1515, the method may include receiving, from the base station, control signaling identifying a configuration for the multi-block machine learning application of the UE at least in part in response to the indication identifying the first UE capability and the second UE capability. In some examples, the control signaling configuring the multi-block machine learning application of the UE may be received in response to the transmission of the indication that the UE supports the multi-block machine learning application at 1505. The operations of 1515 may be performed in accordance with examples as disclosed herein. In some examples, aspects of the operations of 1515 may be performed by a machine learning model configuration component 830 as described with reference to FIG. 8.

At 1520, the method may include communicating with the base station or a wireless device using the multi-block machine learning application configured in accordance with the control signaling. The operations of 1520 may be performed in accordance with examples as disclosed herein. In some examples, aspects of the operations of 1520 may be performed by a machine learning communication component 835 as described with reference to FIG. 8.

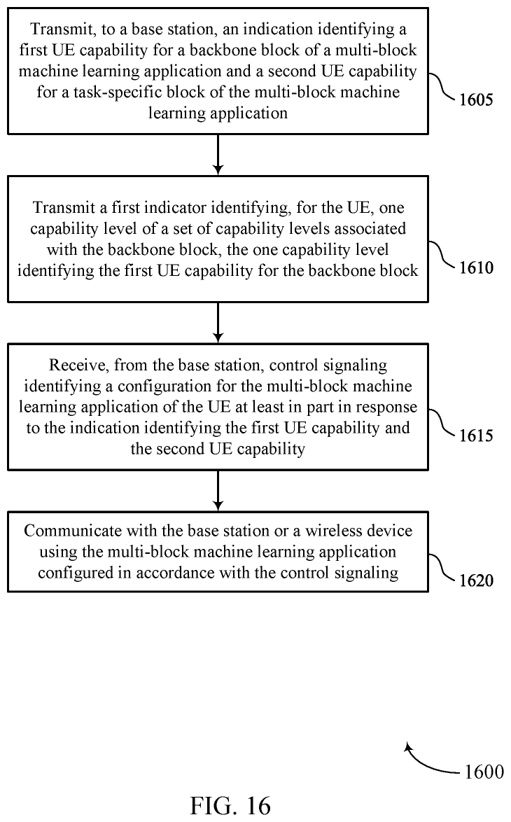

FIG. 16 shows a flowchart illustrating a method 1600 that supports capability indication for a multi-block machine learning model in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include transmitting, to a base station, an indication identifying a first UE capability for a backbone block of a multi-block machine learning application and a second UE capability for a task-specific block of the multi-block machine learning application. The operations of 1605 may be performed in accordance with examples as disclosed herein. In some examples, aspects of the operations of 1605 may be performed by a machine learning model capability component 825 as described with reference to FIG. 8.

At 1610, the method may include transmitting a first indicator identifying, for the UE, one capability level of a set of capability levels associated with the backbone block, the one capability level identifying the first UE capability for the backbone block. The operations of 1610 may be performed in accordance with examples as disclosed herein. In some examples, aspects of the operations of 1610 may be performed by a machine learning model capability component 825 as described with reference to FIG. 8.

At 1615, the method may include receiving, from the base station, control signaling identifying a configuration for the multi-block machine learning application of the UE at least in part in response to the indication identifying the first UE capability and the second UE capability. The operations of 1615 may be performed in accordance with examples as disclosed herein. In some examples, aspects of the operations of 1615 may be performed by a machine learning model configuration component 830 as described with reference to FIG. 8.

At 1620, the method may include communicating with the base station or a wireless device using the multi-block machine learning application configured in accordance with the control signaling. The operations of 1620 may be performed in accordance with examples as disclosed herein. In some examples, aspects of the operations of 1620 may be performed by a machine learning communication component 835 as described with reference to FIG. 8.

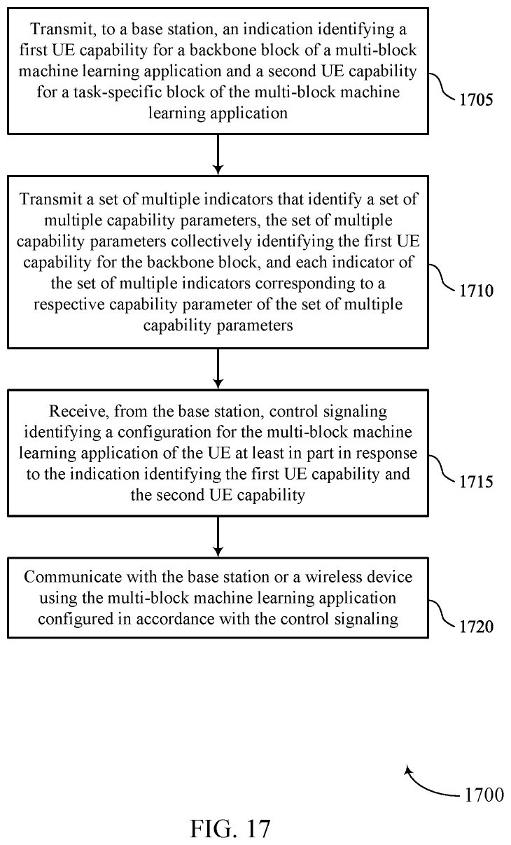

FIG. 17 shows a flowchart illustrating a method 1700 that supports capability indication for a multi-block machine learning model in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include transmitting, to a base station, an indication identifying a first UE capability for a backbone block of a multi-block machine learning application and a second UE capability for a task-specific block of the multi-block machine learning application. The operations of 1705 may be performed in accordance with examples as disclosed herein. In some examples, aspects of the operations of 1705 may be performed by a machine learning model capability component 825 as described with reference to FIG. 8.

At 1710, the method may include transmitting a set of multiple indicators that identify a set of multiple capability parameters, the set of multiple capability parameters collectively identifying the first UE capability for the backbone block, and each indicator of the set of multiple indicators corresponding to a respective capability parameter of the set of multiple capability parameters. The operations of 1710 may be performed in accordance with examples as disclosed herein. In some examples, aspects of the operations of 1710 may be performed by a machine learning model capability component 825 as described with reference to FIG. 8.

At 1715, the method may include receiving, from the base station, control signaling identifying a configuration for the multi-block machine learning application of the UE at least in part in response to the indication identifying the first UE capability and the second UE capability. The operations of 1715 may be performed in accordance with examples as disclosed herein. In some examples, aspects of the operations of 1715 may be performed by a machine learning model configuration component 830 as described with reference to FIG. 8.

At 1720, the method may include communicating with the base station or a wireless device using the multi-block machine learning application configured in accordance with the control signaling. The operations of 1720 may be performed in accordance with examples as disclosed herein. In some examples, aspects of the operations of 1720 may be performed by a machine learning communication component 835 as described with reference to FIG. 8.

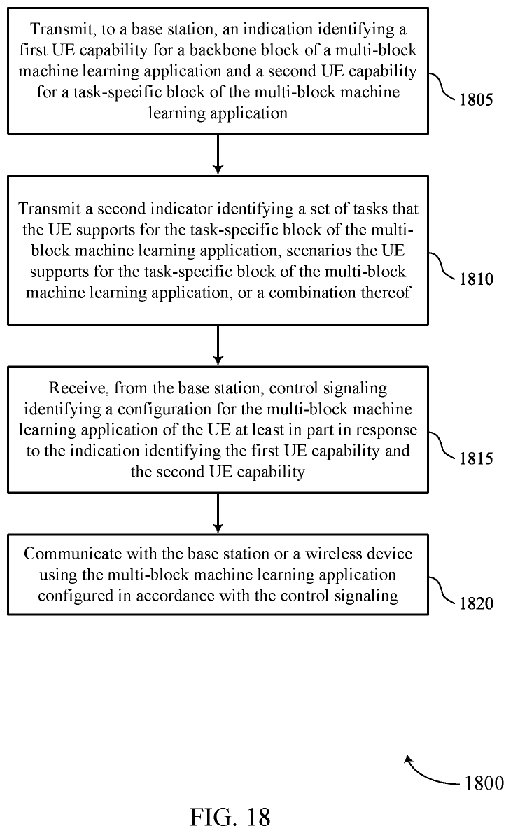

FIG. 18 shows a flowchart illustrating a method 1800 that supports capability indication for a multi-block machine learning model in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1805, the method may include transmitting, to a base station, an indication identifying a first UE capability for a backbone block of a multi-block machine learning application and a second UE capability for a task-specific block of the multi-block machine learning application. The operations of 1805 may be performed in accordance with examples as disclosed herein. In some examples, aspects of the operations of 1805 may be performed by a machine learning model capability component 825 as described with reference to FIG. 8.

At 1810, the method may include transmitting a second indicator identifying a set of tasks that the UE supports for the task-specific block of the multi-block machine learning application, scenarios the UE supports for the task-specific block of the multi-block machine learning application, or a combination thereof. The operations of 1810 may be performed in accordance with examples as disclosed herein. In some examples, aspects of the operations of 1810 may be performed by a machine learning model capability component 825 as described with reference to FIG. 8.

At 1815, the method may include receiving, from the base station, control signaling identifying a configuration for the multi-block machine learning application of the UE at least in part in response to the indication identifying the first UE capability and the second UE capability. The operations of 1815 may be performed in accordance with examples as disclosed herein. In some examples, aspects of the operations of 1815 may be performed by a machine learning model configuration component 830 as described with reference to FIG. 8.

At 1820, the method may include communicating with the base station or a wireless device using the multi-block machine learning application configured in accordance with the control signaling. The operations of 1820 may be performed in accordance with examples as disclosed herein. In some examples, aspects of the operations of 1820 may be performed by a machine learning communication component 835 as described with reference to FIG. 8.

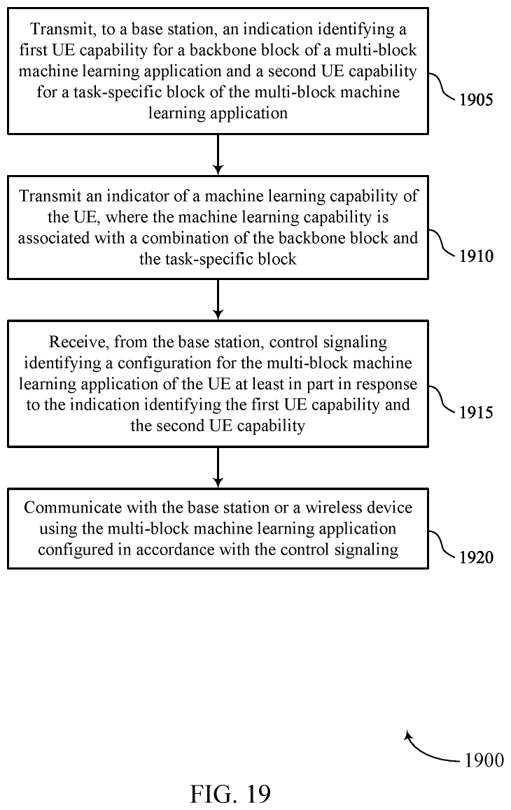

FIG. 19 shows a flowchart illustrating a method 1900 that supports capability indication for a multi-block machine learning model in accordance with aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1905, the method may include transmitting, to a base station, an indication identifying a first UE capability for a backbone block of a multi-block machine learning application and a second UE capability for a task-specific block of the multi-block machine learning application. The operations of 1905 may be performed in accordance with examples as disclosed herein. In some examples, aspects of the operations of 1905 may be performed by a machine learning model capability component 825 as described with reference to FIG. 8.

At 1910, the method may include transmitting an indicator of a machine learning capability of the UE, where the machine learning capability is associated with a combination of the backbone block and the task-specific block. The operations of 1910 may be performed in accordance with examples as disclosed herein. In some examples, aspects of the operations of 1910 may be performed by a machine learning model capability component 825 as described with reference to FIG. 8.

At 1915, the method may include receiving, from the base station, control signaling identifying a configuration for the multi-block machine learning application of the UE at least in part in response to the indication identifying the first UE capability and the second UE capability. The operations of 1915 may be performed in accordance with examples as disclosed herein. In some examples, aspects of the operations of 1915 may be performed by a machine learning model configuration component 830 as described with reference to FIG. 8.

At 1920, the method may include communicating with the base station or a wireless device using the multi-block machine learning application configured in accordance with the control signaling. The operations of 1920 may be performed in accordance with examples as disclosed herein. In some examples, aspects of the operations of 1920 may be performed by a machine learning communication component 835 as described with reference to FIG. 8.

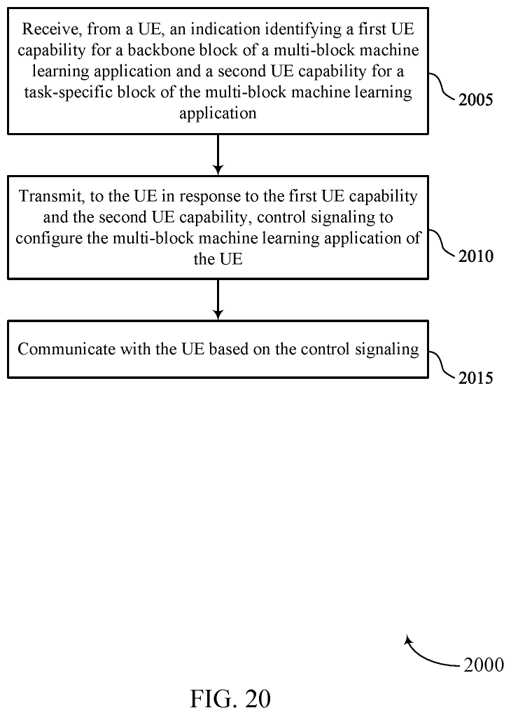

FIG. 20 shows a flowchart illustrating a method 2000 that supports capability indication for a multi-block machine learning model in accordance with aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 2005, the method may include receiving, from a UE, an indication identifying a first UE capability for a backbone block of a multi-block machine learning application and a second UE capability for a task-specific block of the multi-block machine learning application. The operations of 2005 may be performed in accordance with examples as disclosed herein. In some examples, aspects of the operations of 2005 may be performed by a machine learning UE capability component 1225 as described with reference to FIG. 12.

At 2010, the method may include transmitting, to the UE in response to the first UE capability and the second UE capability, control signaling to configure the multi-block machine learning application of the UE. The operations of 2010 may be performed in accordance with examples as disclosed herein. In some examples, aspects of the operations of 2010 may be performed by a machine learning model configuration component 1230 as described with reference to FIG. 12.

At 2015, the method may include communicating with the UE based on the control signaling. The operations of 2015 may be performed in accordance with examples as disclosed herein. In some examples, aspects of the operations of 2015 may be performed by a communication component 1235 as described with reference to FIG. 12.

The following provides an overview of aspects of the present disclosure:

Aspect 1: A method for wireless communications at a UE, comprising: transmitting, to a base station, an indication identifying a first UE capability for a backbone block of a multi-block machine learning application and a second UE capability for a task-specific block of the multi-block machine learning application; receiving, from the base station, control signaling identifying a configuration for the multi-block machine learning application of the UE at least in part in response to the indication identifying the first UE capability and the second UE capability; and communicating with the base station or a wireless device using the multi-block machine learning application configured in accordance with the control signaling.

Aspect 2: The method of aspect 1, further comprising: transmitting, to the base station, an indication that the UE supports the multi-block machine learning application, wherein the control signaling configuring the multi-block machine learning application of the UE is received in response to the indication that the UE supports the multi-block machine learning application.

Aspect 3: The method of any of aspects 1 through 2, wherein transmitting the indication identifying the first UE capability and the second UE capability comprises: transmitting a first indicator identifying, for the UE, one capability level of a set of capability levels associated with the backbone block, the one capability level identifying the first UE capability for the backbone block.

Aspect 4: The method of any of aspects 1 through 3, wherein transmitting the indication identifying the first UE capability and the second UE capability comprises: transmitting a plurality of indicators that identify a plurality of capability parameters, the plurality of capability parameters collectively identifying the first UE capability for the backbone block, and each indicator of the plurality of indicators corresponding to a respective capability parameter of the plurality of capability parameters.

Aspect 5: The method of any of aspects 1 through 4, wherein transmitting the indication identifying the first UE capability and the second UE capability comprises: transmitting a second indicator identifying a set of tasks that the UE supports for the task-specific block of the multi-block machine learning application, scenarios the UE supports for the task-specific block of the multi-block machine learning application, or a combination thereof.

Aspect 6: The method of any of aspects 1 through 5, wherein transmitting the indication identifying the first UE capability and the second UE capability comprises: transmitting an indicator of a machine learning capability of the UE, wherein the machine learning capability is associated with a combination of the backbone block and the task-specific block.

Aspect 7: The method of aspect 6, wherein the machine learning capability of the UE comprises an indicator that the UE supports the multi-block machine learning application and a set of indicators identifying the machine learning capability associated with the combination of the backbone block and the task-specific block.

Aspect 8: The method of any of aspects 6 through 7, wherein the machine learning capability of the UE comprises, for the combination of the backbone block and the task-specific block, a supported size, a supported operation, a machine learning structure type, a supported condition, a supported task, a supported scenario, or a combination thereof.

Aspect 9: The method of any of aspects 1 through 8, wherein the indication identifying the first UE capability and the second UE capability comprises: an indication of neural network types for the backbone block supported by the UE, machine learning model size levels for the backbone block supported by the UE, operation levels for the backbone block supported by the UE, or a combination thereof; and an indication of tasks, scenarios, or a combination thereof, that the UE supports for the task-specific block.

Aspect 10: A method for wireless communications at a network entity, comprising: receiving, from a UE, an indication identifying a first UE capability for a backbone block of a multi-block machine learning application and a second UE capability for a task-specific block of the multi-block machine learning application; transmitting, to the UE in response to the first UE capability and the second UE capability, control signaling to configure the multi-block machine learning application of the UE; and communicating with the UE based at least in part on the control signaling.

Aspect 11: The method of aspect 10, further comprising: receiving, from the UE, an indication that the UE supports the multi-block machine learning application, wherein the control signaling configuring the multi-block machine learning application of the UE is transmitted based at least in part on the UE supporting the multi-block machine learning application.

Aspect 12: The method of any of aspects 10 through 11, wherein receiving the indication identifying the first UE capability and the second UE capability comprises: receiving a first indicator identifying, for the UE, one capability level of a set of capability levels associated with the backbone block, the one capability level identifying the first UE capability for the backbone block.

Aspect 13: The method of any of aspects 10 through 12, wherein receiving the indication identifying the first UE capability and the second UE capability comprises: receiving a plurality of indicators that identify a plurality of capability parameters, the plurality of capability parameters collectively identifying the first UE capability for the backbone block, and each indicator of the plurality of indicators corresponding to a respective capability parameter of the plurality of capability parameters.

Aspect 14: The method of any of aspects 10 through 13, wherein receiving the indication identifying the first UE capability and the second UE capability comprises: receiving a second indicator identifying a set of tasks that the UE supports for the task-specific block of the multi-block machine learning application, scenarios the UE supports for the task-specific block of the multi-block machine learning application, or a combination thereof.

Aspect 15: The method of any of aspects 10 through 14, wherein receiving the indication identifying the first UE capability and the second UE capability comprises: receiving an indicator of a machine learning capability of the UE, wherein the machine learning capability is associated with a combination of the backbone block and the task-specific block; and determining the first UE capability for the backbone block and the second UE capability for the task-specific block based at least in part on the machine learning capability that is associated with the combination of the backbone block and the task-specific block.

Aspect 16: The method of aspect 15, wherein the machine learning capability of the UE comprises an indicator that the UE supports the multi-block machine learning application and a set of indicators identifying the machine learning capability associated with the combination of the backbone block and the task-specific block.

Aspect 17: The method of any of aspects 15 through 16, wherein the machine learning capability of the UE comprises, for the combination of the backbone block and the task-specific block, a supported size, a supported operation, a machine learning structure type, a supported condition, a supported task, a supported scenario, or a combination thereof.

Aspect 18: The method of any of aspects 10 through 17, wherein the indication identifying the first UE capability and the second UE capability comprises: an indication of neural network types for the backbone block supported by the UE, machine learning model size levels for the backbone block supported by the UE, operation levels for the backbone block supported by the UE, or a combination thereof, and an indication of tasks, scenarios, or a combination thereof, that the UE supports for the task-specific block.

Aspect 19: An apparatus for wireless communications at a UE, comprising a processor; memory coupled with the processor; and instructions stored in the memory and executable by the processor to cause the apparatus to perform a method of any of aspects 1 through 9.

Aspect 20: An apparatus for wireless communications at a UE, comprising at least one means for performing a method of any of aspects 1 through 9.

Aspect 21: A non-transitory computer-readable medium storing code for wireless communications at a UE, the code comprising instructions executable by a processor to perform a method of any of aspects 1 through 9.

Aspect 22: An apparatus for wireless communications at a network entity, comprising a processor; memory coupled with the processor; and instructions stored in the memory and executable by the processor to cause the apparatus to perform a method of any of aspects 10 through 18.

Aspect 23: An apparatus for wireless communications at a network entity, comprising at least one means for performing a method of any of aspects 10 through 18.

Aspect 24: A non-transitory computer-readable medium storing code for wireless communications at a network entity, the code comprising instructions executable by a processor to perform a method of any of aspects 10 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting, to a base station, an indication identifying a first UE capability for a backbone block of a multi-block machine learning application and a second UE capability for a task-specific block of the multi-block machine learning application;
receiving, from the base station, control signaling identifying a configuration for the multi-block machine learning application of the UE at least in part in response to the indication identifying the first UE capability and the second UE capability; and
communicating with the base station or a wireless device using the multi-block machine learning application configured in accordance with the control signaling.

2. The method of claim 1, further comprising:
transmitting, to the base station, an indication that the UE supports the multi-block machine learning application, wherein the control signaling configuring the multi-block machine learning application of the UE is received in response to the indication that the UE supports the multi-block machine learning application.

3. The method of claim 1, wherein transmitting the indication identifying the first UE capability and the second UE capability comprises:
transmitting a first indicator identifying, for the UE, one capability level of a set of capability levels associated with the backbone block, the one capability level identifying the first UE capability for the backbone block.

4. The method of claim 1, wherein transmitting the indication identifying the first UE capability and the second UE capability comprises:
transmitting a plurality of indicators that identify a plurality of capability parameters, the plurality of capability parameters collectively identifying the first UE capability for the backbone block, and each indicator of the plurality of indicators corresponding to a respective capability parameter of the plurality of capability parameters.

5. The method of claim 1, wherein transmitting the indication identifying the first UE capability and the second UE capability comprises:
transmitting a second indicator identifying a set of tasks that the UE supports for the task-specific block of the multi-block machine learning application, scenarios the UE supports for the task-specific block of the multi-block machine learning application, or a combination thereof.

6. The method of claim 1, wherein transmitting the indication identifying the first UE capability and the second UE capability comprises:
transmitting an indicator of a machine learning capability of the UE, wherein the machine learning capability is associated with a combination of the backbone block and the task-specific block.

7. The method of claim 6, wherein the machine learning capability of the UE comprises an indicator that the UE supports the multi-block machine learning application and a set of indicators identifying the machine learning capability associated with the combination of the backbone block and the task-specific block.

8. The method of claim 6, wherein the machine learning capability of the UE comprises, for the combination of the backbone block and the task-specific block, a supported size, a supported operation, a machine learning structure type, a supported condition, a supported task, a supported scenario, or a combination thereof.

9. The method of claim 1, wherein the indication identifying the first UE capability and the second UE capability comprises:
an indication of neural network types for the backbone block supported by the UE, machine learning model size levels for the backbone block supported by the UE, operation levels for the backbone block supported by the UE, or a combination thereof, and
an indication of tasks, scenarios, or a combination thereof, that the UE supports for the task-specific block.

10. A method for wireless communications at a network entity, comprising:
receiving, from a user equipment (UE), an indication identifying a first UE capability for a backbone block of a multi-block machine learning application and a second UE capability for a task-specific block of the multi-block machine learning application;
transmitting, to the UE in response to the first UE capability and the second UE capability, control signaling to configure the multi-block machine learning application of the UE; and
communicating with the UE based at least in part on the control signaling.

11. The method of claim 10, further comprising:
receiving, from the UE, an indication that the UE supports the multi-block machine learning application, wherein the control signaling configuring the multi-block machine learning application of the UE is transmitted based at least in part on the UE supporting the multi-block machine learning application.

12. The method of claim 10, wherein receiving the indication identifying the first UE capability and the second UE capability comprises:
receiving a first indicator identifying, for the UE, one capability level of a set of capability levels associated with the backbone block, the one capability level identifying the first UE capability for the backbone block.

13. The method of claim 10, wherein receiving the indication identifying the first UE capability and the second UE capability comprises:
receiving a plurality of indicators that identify a plurality of capability parameters, the plurality of capability parameters collectively identifying the first UE capability for the backbone block, and each indicator of the plurality of indicators corresponding to a respective capability parameter of the plurality of capability parameters.

14. The method of claim 10, wherein receiving the indication identifying the first UE capability and the second UE capability comprises:
receiving a second indicator identifying a set of tasks that the UE supports for the task-specific block of the multi-block machine learning application, scenarios the UE supports for the task-specific block of the multi-block machine learning application, or a combination thereof.

15. The method of claim 10, wherein receiving the indication identifying the first UE capability and the second UE capability comprises:
receiving an indicator of a machine learning capability of the UE, wherein the machine learning capability is associated with a combination of the backbone block and the task-specific block; and
determining the first UE capability for the backbone block and the second UE capability for the task-specific block based at least in part on the machine learning capability that is associated with the combination of the backbone block and the task-specific block.

16. The method of claim 15, wherein the machine learning capability of the UE comprises an indicator that the UE supports the multi-block machine learning application and a set of indicators identifying the machine learning capability associated with the combination of the backbone block and the task-specific block.

17. The method of claim 15, wherein the machine learning capability of the UE comprises, for the combination of the backbone block and the task-specific block, a supported size, a supported operation, a machine learning structure type, a supported condition, a supported task, a supported scenario, or a combination thereof.

18. The method of claim 10, wherein the indication identifying the first UE capability and the second UE capability comprises:
an indication of neural network types for the backbone block supported by the UE, machine learning model size levels for the backbone block supported by the UE, operation levels for the backbone block supported by the UE, or a combination thereof, and
an indication of tasks, scenarios, or a combination thereof, that the UE supports for the task-specific block.

19. An apparatus for wireless communications at a user equipment (UE), comprising:
a processor;
memory coupled with the processor; and
instructions stored in the memory and executable by the processor to cause the apparatus to:
transmit, to a base station, an indication identifying a first UE capability for a backbone block of a multi-block machine learning application and a second UE capability for a task-specific block of the multi-block machine learning application;
receive, from the base station, control signaling identifying a configuration for the multi-block machine learning application of the UE at least in part in response to the indication identifying the first UE capability and the second UE capability; and
communicate with the base station or a wireless device using the multi-block machine learning application configured in accordance with the control signaling.

20. The apparatus of claim 19, wherein the instructions are further executable by the processor to cause the apparatus to:
transmit, to the base station, an indication that the UE supports the multi-block machine learning application, wherein the control signaling configuring the multi-block machine learning application of the UE is received in response to the indication that the UE supports the multi-block machine learning application.

21. The apparatus of claim 19, wherein the instructions to transmit the indication identifying the first UE capability and the second UE capability are executable by the processor to cause the apparatus to:
transmit a first indicator identifying, for the UE, one capability level of a set of capability levels associated with the backbone block, the one capability level identifying the first UE capability for the backbone block.

22. The apparatus of claim 19, wherein the instructions to transmit the indication identifying the first UE capability and the second UE capability are executable by the processor to cause the apparatus to:
transmit a plurality of indicators that identify a plurality of capability parameters, the plurality of capability parameters collectively identifying the first UE capability for the backbone block, and each indicator of the plurality of indicators corresponding to a respective capability parameter of the plurality of capability parameters.

23. The apparatus of claim 19, wherein the instructions to transmit the indication identifying the first UE capability and the second UE capability are executable by the processor to cause the apparatus to:
transmit a second indicator identifying a set of tasks that the UE supports for the task-specific block of the multi-block machine learning application, scenarios the UE supports for the task-specific block of the multi-block machine learning application, or a combination thereof.

24. The apparatus of claim 19, wherein the instructions to transmit the indication identifying the first UE capability and the second UE capability are executable by the processor to cause the apparatus to:
transmit an indicator of a machine learning capability of the UE, wherein the machine learning capability is associated with a combination of the backbone block and the task-specific block.

25. The apparatus of claim 24, wherein the machine learning capability of the UE comprises an indicator that the UE supports the multi-block machine learning application and a set of indicators identifying the machine learning capability associated with the combination of the backbone block and the task-specific block.

26. The apparatus of claim 24, wherein the machine learning capability of the UE comprises, for the combination of the backbone block and the task-specific block, a supported size, a supported operation, a machine learning structure type, a supported condition, a supported task, a supported scenario, or a combination thereof.

27. The apparatus of claim 19, wherein the instructions to indication identify the first UE capability and the second UE capability are executable by the processor to cause the apparatus to:
an indication of neural network types for the backbone block support by the UE, machine learning model size levels for the backbone block supported by the UE, operation levels for the backbone block supported by the UE, or a combination thereof, and
an indication of tasks, scenarios, or a combination thereof, that the UE support for the task-specific block.

28. An apparatus for wireless communications at a network entity, comprising:
a processor;
memory coupled with the processor; and
instructions stored in the memory and executable by the processor to cause the apparatus to:
receive, from a user equipment (UE), an indication identifying a first UE capability for a backbone block of a multi-block machine learning application and a second UE capability for a task-specific block of the multi-block machine learning application;
transmit, to the UE in response to the first UE capability and the second UE capability, control signaling to configure the multi-block machine learning application of the UE; and
communicate with the UE based at least in part on the control signaling.

29. The apparatus of claim 28, wherein the instructions are further executable by the processor to cause the apparatus to:
receive, from the UE, an indication that the UE supports the multi-block machine learning application, wherein the control signaling configuring the multi-block machine learning application of the UE is transmitted based at least in part on the UE supporting the multi-block machine learning application.

30. The apparatus of claim 28, wherein the instructions to receive the indication identifying the first UE capability and the second UE capability are executable by the processor to cause the apparatus to:
receive a first indicator identifying, for the UE, one capability level of a set of capability levels associated with the backbone block, the one capability level identifying the first UE capability for the backbone block.
